(19) United States
(12) Patent Application Publication
(10) Pub. No.: US 2026/0051933 A1
(43) Pub. Date: Feb. 19, 2026

(54) RU JPTA CAPABILITY FOR FRONTHAUL

(71) Applicant: Samsung Electronics Co., Ltd., Suwon-si (KR)

(72) Inventors: Xinliang Zhang, Plano, TX (US); Ahmad AlAmmouri, Richardson, TX (US); Young Han Nam, Plano, TX (US)

(21) Appl. No.: 19/195,692

(22) Filed: Apr. 30, 2025

Related U.S. Application Data
(60) Provisional application No. 63/682,935, filed on Aug. 14, 2024.

(51) Int. Cl. H04B 7/06

(52) U.S. Cl. CPC H04B 7/0619

(57) ABSTRACT

Apparatus and methods for radio unit (RU) joint phase-time array (JPTA) capability for fronthaul communications. A method performed by a radio unit (RU) includes transmitting, to a distributed unit (DU) via a management-plane (M-plane) of a fronthaul interface, information indicating support for joint phase-time array (JPTA) beamforming, transmitting, to the DU, beamforming capability information associated with a frontend architecture of a transceiver of the RU, and receiving, from the DU, a JPTA configuration based on the beamforming capability information. The method further includes identifying a JPTA beam to apply based on the JPTA configuration and transmitting, to one or more user equipment (UEs), the JPTA beam.

### CROSS-REFERENCE TO RELATED AND CLAIM OF PRIORITY

The present application claims priority under 35 U.S.C. § 119 (e) to U.S. Provisional Patent Application No. 63/682,935 filed on Aug. 14, 2024, which is hereby incorporated by reference in its entirety.

### TECHNICAL FIELD

The present disclosure relates generally to wireless communication systems and, more specifically, the present disclosure relates to radio unit (RU) joint phase-time array (JPTA) capability for fronthaul communications.

### BACKGROUND

As wireless communication has grown and the number of subscribers to wireless communication services continues to grow quickly, the demand for wireless data traffic is rapidly increasing due to the growing popularity among consumers and businesses. To meet the high growth in mobile data traffic and support new applications and deployments, improvements in radio interface efficiency and coverage are of paramount importance. Moreover, this demand for wireless data traffic has increased since the deployment of 4G communication systems, and to enable various vertical applications, 5G (e.g., fifth generation) communication systems have been developed and are currently being deployed. Several characteristics of such applications have also been considered. A basic philosophy of 5G or New Radio (NR) in the 3rd Generation Partnership Project (3GPP) is to support beam-specific operations for wireless communication between a gNodeB (gNB) and user equipment (UE). Several components in the 5G NR specification can efficiently be operated in a beam-specific manner. Note that the 5G communication system involves implementation to include higher frequency millimeter-wave (mmWave) bands, such as 28 GHz or 60 GHz bands or, in general, above 6 GHz bands, to accomplish higher data rates, or in lower frequency bands, such as below 6 GHz, to enable robust coverage and mobility support.

### SUMMARY

The present disclosure relates to RU JPTA capability for fronthaul.

In one embodiment, a RU is provided. The RU includes a fronthaul interface configured to transmit, to a distributed unit (DU) via a management-plane (M-plane), information indicating support for JPTA beamforming; transmit, to the DU, beamforming capability information associated with a frontend architecture of a transceiver of the RU; and receive, from the DU, a JPTA configuration based on the beamforming capability information. The RU further includes a processor operably coupled with the fronthaul interface and the transceiver. The processor is configured to identify a JPTA beam to apply based on the JPTA configuration. The transceiver configured to transmit, to one or more user equipment (UEs), the JPTA beam.

In another embodiment, a DU is provided. The DU includes a fronthaul interface configured to receive, from a RU via a M-plane, information indicating support for JPTA beamforming and receive, from the RU, beamforming capability information associated with a frontend architecture of a transceiver of the RU. The DU further includes a processor operably coupled with the fronthaul interface. The processor is configured to determine a JPTA configuration based on the information indicating support for JPTA beamforming and the beamforming capability information. The fronthaul interface is further configured to transmit, to the RU, the JPTA configuration to indicate a JPTA beam to apply for a transmission.

In yet another embodiment, a method performed by a RU is provided. The method includes transmitting, to a DU via a M-plane of a fronthaul interface, information indicating support for JPTA beamforming, transmitting, to the DU, beamforming capability information associated with a frontend architecture of a transceiver of the RU, and receiving, from the DU, a JPTA configuration based on the beamforming capability information. The method further includes identifying a JPTA beam to apply based on the JPTA configuration and transmitting, to one or more UEs, the JPTA beam.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Definitions for other certain words and phrases are provided throughout this patent document. Those of ordinary skill in the art should understand that in many, if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example base station (BS) according to embodiments of the present disclosure;

FIG. 3 illustrates an example of a user equipment (UE) according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of a hybrid beamforming structure according to embodiments of the present disclosure;

FIG. 7 illustrates an example of a JPTA beamforming according to embodiments of the present disclosure;

FIG. 8 illustrates an example of a JPTA circuit according to embodiments of the present disclosure;

FIG. 9 illustrates a diagram of example methods and configurations according to embodiments of the present disclosure;

FIG. 10 illustrates a diagram of an example fronthaul signaling according to embodiments of the present disclosure;

FIG. 11 illustrates a diagram of example fronthaul signaling according to embodiments of the present disclosure;

FIG. 12 illustrates tables of example delay units for horizontal and vertical antenna elements according to embodiments of the present disclosure;

FIG. 13 illustrates diagrams of example JPTA frontend architectures according to embodiments of the present disclosure;

FIG. 14 illustrates a diagram of an example azimuth only JPTA architecture according to embodiments of the present disclosure;

FIG. 15 illustrates a diagram of example fronthaul signaling according to embodiments of the present disclosure;

FIG. 16 illustrates a diagram of an example JPTA beam identifier (ID) according to embodiments of the present disclosure;

FIG. 17 illustrates a diagram of an example JPTA beam ID according to embodiments of the present disclosure;

FIG. 18 illustrates a diagram of an example fronthaul signaling according to embodiments of the present disclosure;

FIG. 19 illustrates a diagram of an example JPTA beam ID according to embodiments of the present disclosure;

FIG. 20 illustrates a diagram of an example beam ID space indication according to embodiments of the present disclosure;

FIG. 21 illustrates diagrams of example fronthaul signaling according to embodiments of the present disclosure;

FIGS. 22A and 22B illustrate examples of JPTA beam IDs according to embodiments of the present disclosure;

FIG. 23 illustrates a diagram of an example JPTA indication according to embodiments of the present disclosure;

FIG. 24 illustrates a diagram of an example JPTA indication according to embodiments of the present disclosure;

FIG. 25 illustrates diagrams of example fronthaul signaling according to embodiments of the present disclosure;

FIG. 26 illustrates diagrams of example fronthaul signaling according to embodiments of the present disclosure;

FIG. 27 illustrates a diagram of an example JPTA indication according to embodiments of the present disclosure;

FIG. 28 illustrates diagrams of example subband configurations according to embodiments of the present disclosure;

FIGS. 29A and 29B illustrate diagrams of example JPTA indications according to embodiments of the present disclosure;

FIGS. 30A and 30B illustrate diagrams of example JPTA configurations for RU frontend architectures according to embodiments of the present disclosure;

FIG. 31 illustrate diagrams of example fronthaul signaling according to embodiments of the present disclosure;

FIG. 32 illustrate diagrams of example fronthaul signaling according to embodiments of the present disclosure; and

FIG. 33 illustrates an example method performed by an RU in a wireless communication system according to embodiments of the present disclosure.

### DETAILED DESCRIPTION

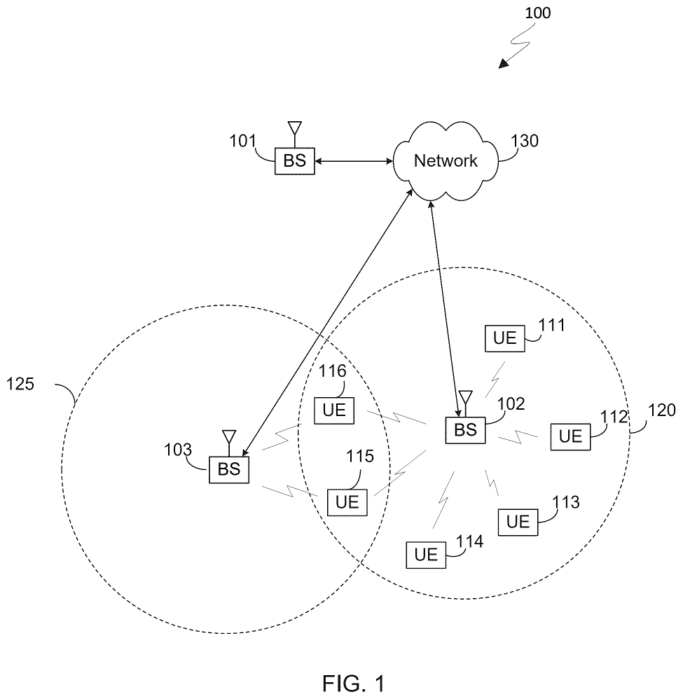

FIGS. 1-33, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since the deployment of 4G communication systems, efforts have been made to develop an improved 5G or pre-5G communication system. Therefore, the 5G or pre-5G communication system is also called a “beyond 4G network” or a “post LTE system”.

The 5G communication system is implemented in higher frequency (mm Wave) bands, e.g., 60 GHz bands, to accomplish higher data rates. To decrease propagation loss of the radio waves and increase the transmission coverage, the beamforming, massive multiple-input multiple-output (MIMO), full dimensional MIMO (FD-MIMO), array antenna, an analog beam forming, large scale antenna techniques and the like are discussed in 5G communication systems.

In addition, in 5G communication systems, development for system network improvement is underway based on advanced small cells, cloud radio access networks (RANs), ultra-dense networks, device-to-device (D2D) communication, wireless backhaul communication, moving network, cooperative communication, coordinated multi-points (COMP) transmission and reception, interference mitigation and cancelation and the like.

In the 5G system, Hybrid frequency-shift keying (FSK) and Quadrature Amplitude Modulation (QAM) Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or another data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for receiving JPTA beams. In certain embodiments, one or more of the gNBs 101-103 include circuitry, programing, or a combination thereof for supporting RU JPTA capability for fronthaul.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

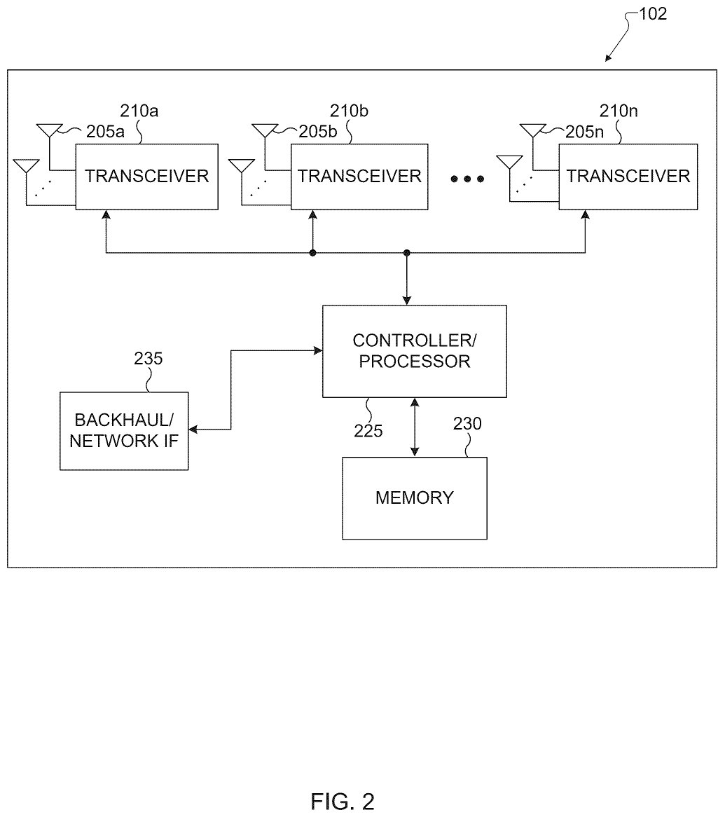

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, a backhaul or network interface 235, and a fronthaul interface 240.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for RU JPTA capability for fronthaul as described in greater detail below. Any of a wide variety of other functions could be supported in the gNB 102 by the controller/processor 225. The controller/processor 225 is also capable of executing programs and other processes resident in the memory 230. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs. For example, as discussed in greater detail, various components of the gNB 102 may be distributed or separated into different units such as an RU and DU. The RU may include the transceivers 210 and antennas 205 as well as, in some embodiments, components of the processor/controller 225. The RU may further include a fronthaul interface to communicate with the DU. The DU may include the components of the processor/controller 225. The DU may further include a fronthaul interface to communicate with the RU.

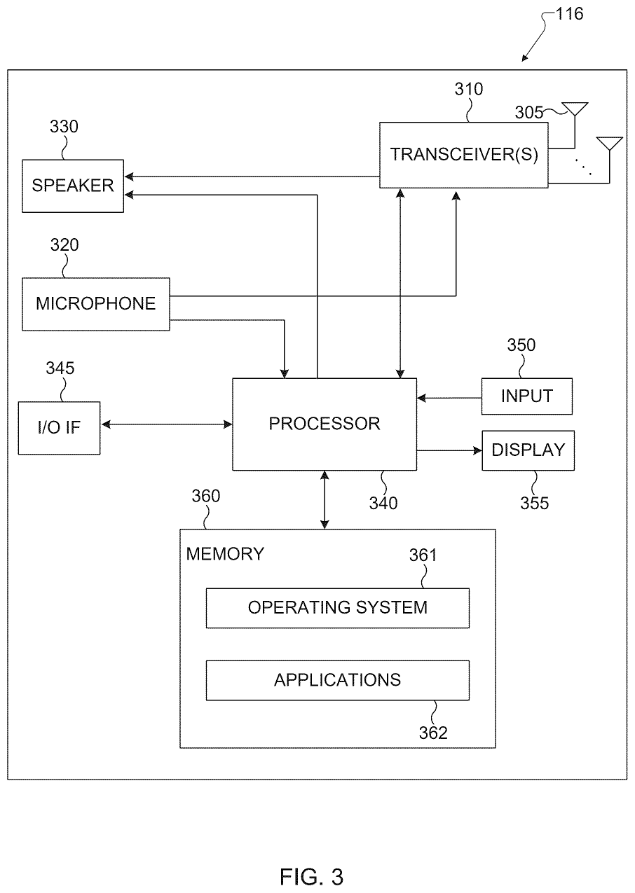

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna(s) 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of downlink (DL) channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for receiving JPTA beams. The processor 340 can move data into or out of the memory 360 as required by an executing process. For example, in various embodiments, the UE 116 uses JPTA beamforming for DL receptions from eNB 102 and/or 103 for mobility robustness.

In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

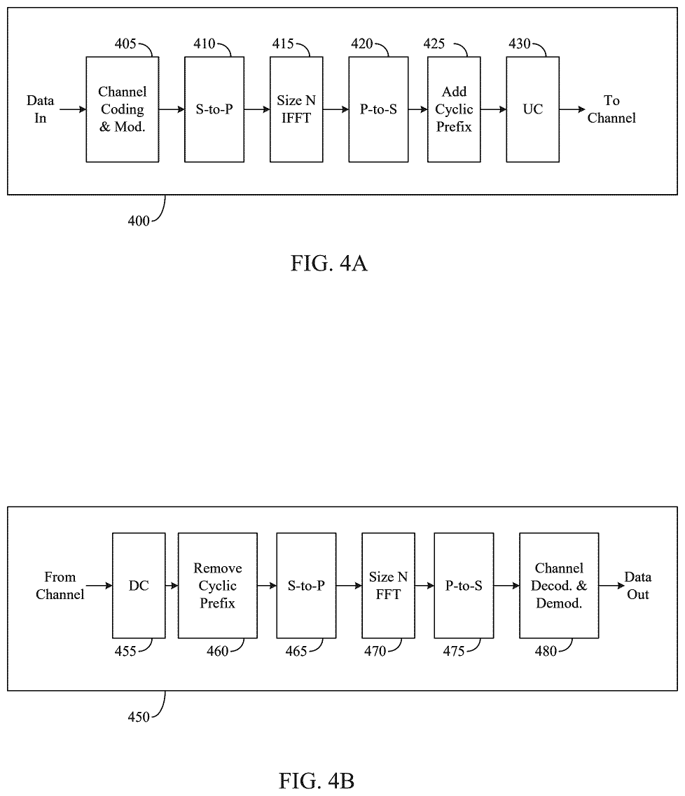

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured for transmitting power adaptation for coverage enhancement as described in embodiments of the present disclosure. In some embodiments, the receive path 450 is configured for receiving power adaptation for coverage enhancement as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

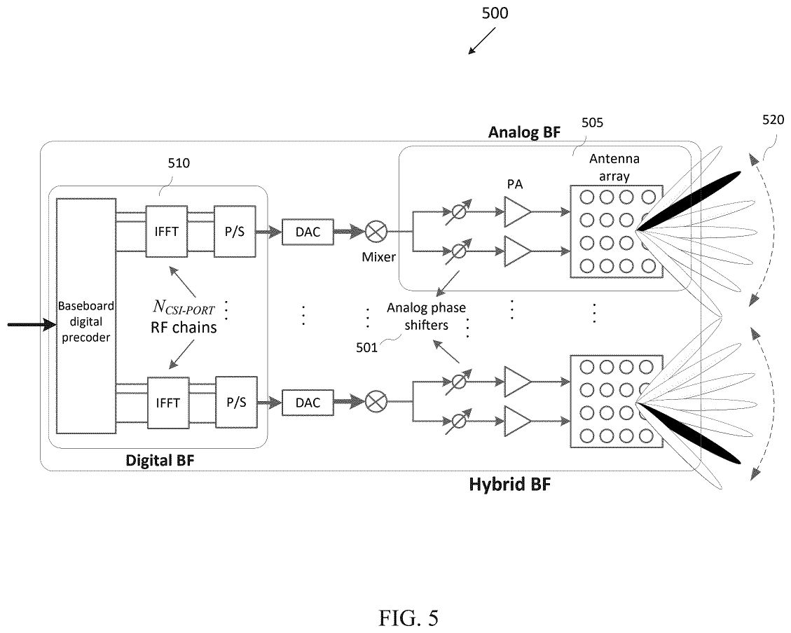

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports NCSI-PORT. A digital beamforming unit 510 performs a linear combination across NGSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are necessary to compensate for the additional path loss.

Analog beamforming relies on analog hardware such as phase-shifters and switches to create the beam shapes. However, these analog hardware components create a frequency-flat response. Components of the input signal frequency undergo a similar transformation after passing through them. This reduces the flexibility of the beamforming.

Embodiments of the present disclosure recognize that, due to the rising demand for traffic, wireless systems are moving towards higher frequency of operation, such as millimeter-wave (mm-wave) and terahertz (THz) frequencies, where abundant spectrum is available. However, the higher frequencies also suffer from a high channel propagation loss, and therefore require a large antenna array to create sufficient beamforming gain to ensure sufficient link budget for operation. Thus, these high frequency systems are usually built with a large antenna array at the transmitter and/or the receiver containing many individual antenna elements. At the operating bandwidths of these mm-wave and THz systems, the cost and power consumption of mixed-signal components such as analog-to-digital converters (ADCs) and/or digital-to-analog converters (DACs) also grows tremendously. Thus, fully digital transceiver implementations, where each antenna element is fed by a dedicated radio-frequency (RF) chain, may not be practical. To keep the hardware cost and power consumption of such large antenna arrays manageable, typically an analog beamforming or hybrid beamforming architecture is adopted where the large antenna array is fed with a much smaller number of RF chains via the use of analog hardware such as phase-shifters. This reduces the number of mixed-signal components which significantly reduces the cost, size, and power consumption of the transceivers. When transmitting a signal at the transmitter, a combination of digital beamforming before DAC and analog beamforming using the phase-shifters is used to create the overall beam shape in the desired direction. Similarly, when receiving a signal at the receiver, a combination of analog beamforming using phase-shifters and digital beamforming after ADC is used to create the overall beam shape in the desired direction.

Accordingly, various embodiments of the present disclosure utilize frequency-dependent hybrid beamforming, which is referred to as JPTA beamforming. Note that, here, frequency-dependent beamforming refers to a technique where different components of the input signal may encounter a differently shaped analog beam based on their frequency.

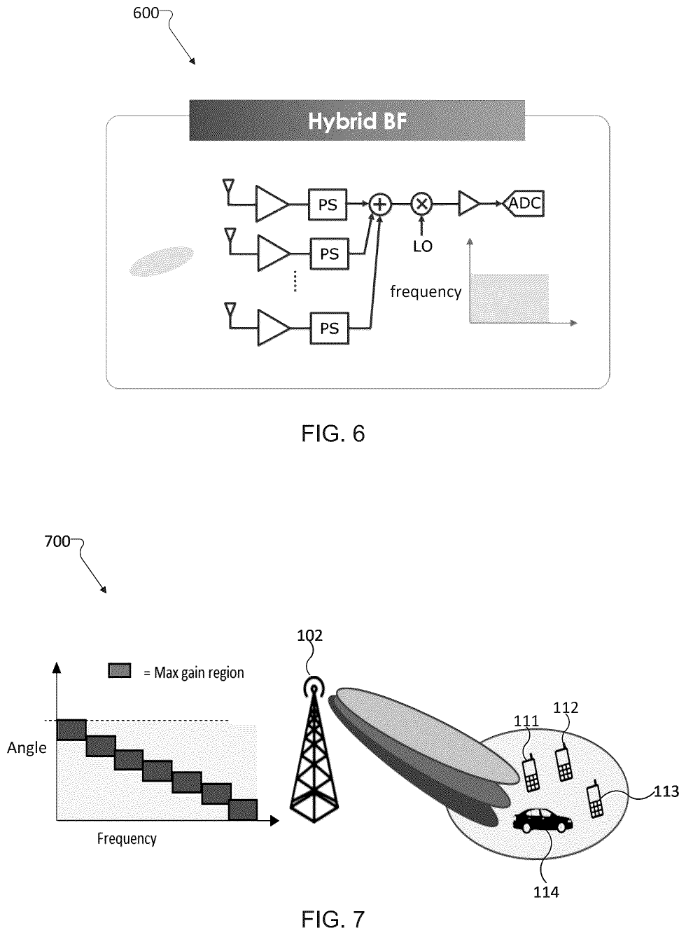

FIG. 6 illustrates an example of a hybrid beamforming structure 600 according to embodiments of the present disclosure. For example, hybrid beamforming structure 600 can be implemented in the BS 103 of FIG. 1. This example is for illustration only and other embodiments can be used without departing from the scope of the present disclosure.

However, other approaches usually use a phase-shifter array or a combination of phase-shifters and switches to connect the large antenna array to a few of RF chains. With reference to FIG. 6, an example of such an architecture is shown, where each antenna element is connected through a dedicated phase shifter.

FIG. 7 illustrates an example of a JPTA beamforming 700 according to various embodiments of the present disclosure. For example, the JPTA beamforming 700 provides an example of the frequency varying linearly over the system bandwidth and the angular direction sweeping linearly over a certain region according to embodiments of the present disclosure. For example, the JPTA beamforming 700 may be performed in network 130 by BS 102. The JPTA beamforming 700 is for illustration only and other embodiments can be used without departing from the scope of the present disclosure.

In one example behavior of JPTA operation, the maximum gain region of the beam sweeps over an angle range as the signal frequency varies. At any signal frequency f, the desired beam creates the maximum array-gain in one angular direction θ(f). As f varies linearly over the system bandwidth, the angular direction θ(f) also sweeps linearly over a certain angular region

$$[ {θ}_{0} - \frac{Δθ}{2} , {θ}_{0} - \frac{Δθ}{2} ] ,$$

as shown in FIG. 7. Embodiments in this disclosure can be applied to other behaviors of JPTA operation as well.

For example, with reference to FIG. 7, the case of hybrid beamforming at a base-station (BS) is shown with a single RF chain, i.e., R=1. Note that with M antennas, the maximum beamforming gain in any direction is M. For the BS to provide signal coverage to the UEs in the cell, the BS would perform beam sweeping over time for its frequency-flat beams. With reference to FIG. 7, the analog beamforming with beam sweeping is shown.

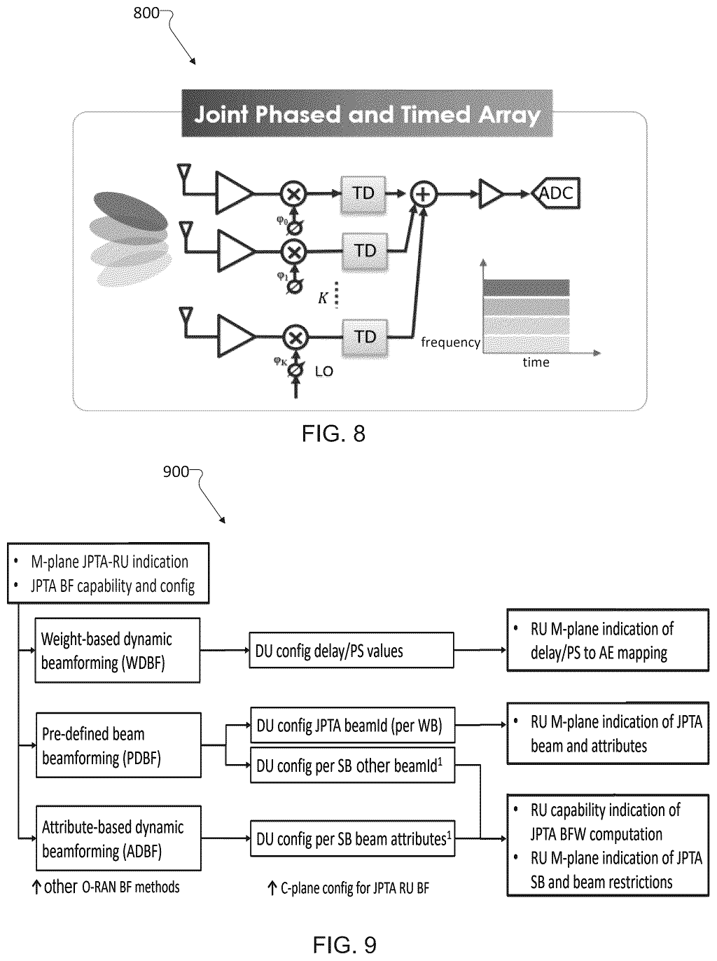

FIG. 8 illustrates an example of a JPTA circuit 800 according to embodiments of the present disclosure. For example, JPTA circuit 800 may be implemented in BS 102 and, more particularly, in one or more of the transceivers 210. This example is for illustration only and other embodiments can be used without departing from the scope of the present disclosure.

An alternative to frequency-flat hybrid beamforming is frequency-dependent hybrid beamforming, which is called joint phase-time array (JPTA) beamforming. Note that, here, frequency-dependent beamforming refers to a technique where different components of the input signal may encounter a differently shaped analog beam based on their frequency. To this end, delay elements are utilized in addition to the common phase shifters to create the desired frequency-dependent beam. With reference to FIG. 8, each antenna is connected through a time delay (TD) element and a phase shifter as shown, these TD elements and phase shifters are components of the frontend architecture of the JPTA circuit 800 and BS 102, which in addition to the amplifiers, mixers, and local oscillators (LOs) are included in the respective transceivers 210.

By tuning the delay elements and phase shifters, different frequency-dependent beams can be designed. For example, a rainbow beam (aka continues-angle or prism beam) can be designed, a 2D beam pattern for JPTA rainbow beam, where angles in [−60,60] are associated with a bundle of subcarriers that provides high beam gain. For this design, every azimuth angle is covered by a bundle of subcarriers with a high beam gain. This design is especially useful for beam training or for data multiplying when the cell is highly loaded (many UEs at different angles are associated with the BS). In another design, a 2D beam pattern for JPTA discrete-angle beam, where the angles in [−30, −15, 15, 30] are associated with distinct bundles of subcarriers that provide high beam gain. In this case, the BS designs the JPTA to maximize the beam gain for UEs at different angles over distinct continuous sets of subcarriers. For data transmission, this design is more useful since it can be tailored based on the locations of the UEs and is beneficial even if only two UEs are served by the BS.

In contrast to the phased-array beamforming shown in FIG. 7, UEs at different angles can be served at the same over distinct bundles of sub-carriers without the need for beam sweeping. For example, UEs at [−30, −15, 15, 30] can be simultaneously served over the corresponding subcarrier (i.e., frequency sub-bands). As a result, every UE (e.g., the UE 116) has access to the channel at times, which can be exploited for different purposes including fast beam-training, uplink coverage extension, and mobility enhancement.

To design the beams, different approaches have been provided. For the rainbow beam, delays are set with a constant increment between them, and hence, the complexity for designing this kind of beam is very low. For the discrete-angle beam type, an iterative approach may be used, which yields high beam gains, while a simple analytical approach could alternatively be used. The beam gain for the iterative approach is typically higher than the analytical approach but at the price of high complexity. Regardless of which approach or algorithm is used to design the JPTA beam, the output is in the form of phases and delays that are used to configure the delay elements and the phase shifters in order to achieve the desired beam pattern.

Although embodiments of the present disclosure provide a cellular network (e.g., the network 130) where the JPTA beam is designed at the BS side, it is not limited to this application. The disclosure could be applied to other systems such as WiFi as well as designing beams at the UE side.

Other RUs deployed in FR1 or FR2 use digital, analog, or hybrid beamforming (BF). However, JPTA is a type of beamforming that relies on frequency dependent analog beams. Embodiments of the present disclosure recognize that the open radio access network (O-RAN) specification does not have standardized JPTA capability so that a distributed unit (DU) is not able to:
Compute JPTA BF weights without knowing delay unit configuration;
Use RU hardcoded JPTA beams or define JPTA beams for the C-plane signaling;
Schedule physical resource according to JPTA RU restrictions;
Adapt variations of JPTA related RU capability.

Thus, embodiments of the present disclosure recognize that the interoperability between JPTA RU and DU is desired.

FIG. 9 illustrates a diagram of example methods and configurations 900 according to embodiments of the present disclosure. For example, methods and configurations 900 may be performed and implemented by the BS 102 of FIG. 1. This example is for illustration only and other embodiments can be used without departing from the scope of the present disclosure.

Embodiments of the present disclosure provided for standardizing JPTA capability to ensure interoperability between JPTA RU and DU in O-RAN system. This disclosure provides fronthaul signaling, including in M-plane and C-plane, to support JPTA RU and DU in O-RAN. With reference to FIG. 9, the relevance of embodiment herein to the O-RAN specification are illustrated.

In one embodiment, RU informs DU the JPTA capability through M-plane. The JPTA capability includes a flag that RU utilizes JPTA array, the beamforming method(s) RU supports, and the required M-plane parameters: JPTA capability of the RU affects the scheduling and configuration operations at the DU. Depending on the BF types that RU supports, RU reports the related capability to the DU.

In another embodiment, RU informs DU the delay-unit to antenna element (AE) mapping through M-plane: In RU hardware, the delay unit can be per antenna port or shared by multiple AEs. In an embodiment, RU informs DU the antenna array architecture related information, including delay unit to AE mapping. DU may use this information for scheduling purpose and BF weight computation purpose.

In another embodiment, JPTA beam is defined with per subband beam information: O-RAN fronthaul utilizing beamIds for an efficient RU BF configuration. In this embodiment, the beamId are expanded to support JPTA beams, which have multiple beams for different subband.

In another embodiment, RU capability of computing JPTA BF is based on DU per subband configuration. In this embodiment, DU configures BF weights or beam attributes per subband, and RU integrates the configuration and computes the JPTA BF weights for its JPTA array. RU informs/implies DU the supported BF type and the restriction of the RU computed JPTA beams through M-plane.

JPTA capability of the RU affects the scheduling and configuration operations at the DU. Standardize JPTA capability ensures interoperability between JPTA RU and DU in O-RAN system. If the RU supports JPTA array, the RU informs DU the JPTA capability through M-plane.

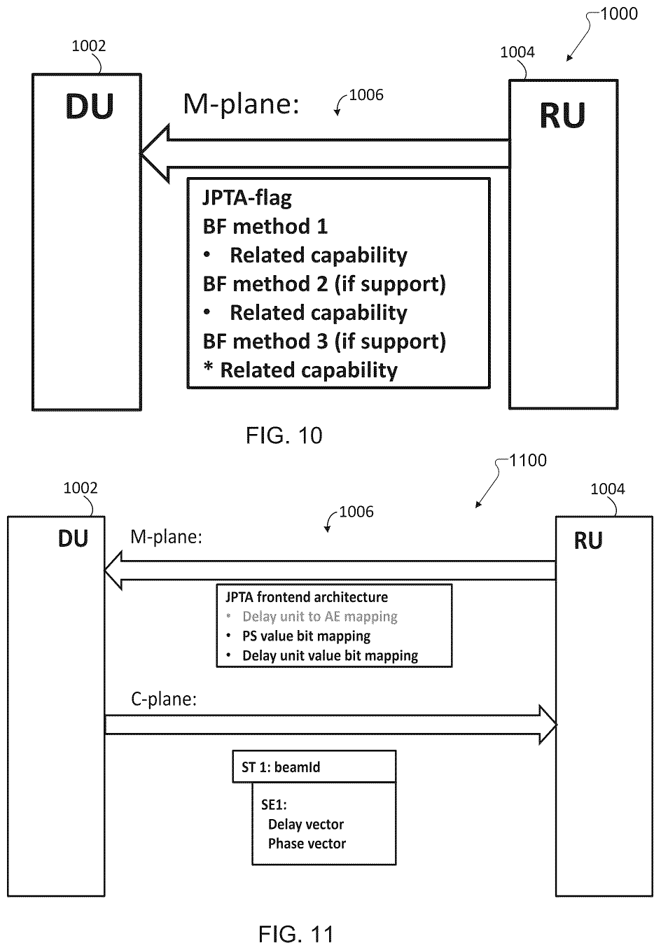

FIG. 10 illustrates a diagram of an example fronthaul signaling 1000 according to embodiments of the present disclosure. For example, fronthaul signaling 1000 implemented in the BS 102 of FIG. 1. This example is for illustration only and other embodiments can be used without departing from the scope of the present disclosure.

As illustrated in FIGS. 10 and 11, the DU 1002 performs management and control functions and communicates with one or more RU(s) 1004 over a fronthaul interface 1006 which exists between the DU 1002 and the RU 1004. For example, the RU 1004 may be implemented by/include the transceivers 210 and antennas 205 as well as, in some embodiments, components of the processor/controller 225, while the DU 1002 may include the components of the processor/controller 225. The fronthaul interface 1006 includes a management (M)-plane for management related communications and a control (C)-plane for control related communications between the DU 1002 and the RU 1004.

In an embodiment, the RU 1004 informs a flag through M-plane indicating the RU 1004 has an JPTA array. The DU 1002 recognizes the RU 1004 has a JPTA array and interacts with the RU 10004 accordingly.
In an example, the JPTA is a feature of the RU 1004. RU 1004 reports this feature through M-plane. The other JPTA related capabilities can be supported by the RU 1004 if RU 1004 informs this feature through M-plane.
   The RU 1004 supporting JPTA has a dedicated feature, named for example “O-RU-JPTA-ARRAY”:
   feature O-RU-JPTA-ARRAY {
      description “This feature indicates that the O-RU utilizes JPTA frontend}”;
   }
In another example, the JPTA is a type of RU tx-array and rx-array. RU 1004 informs the array type as JPTA array. The other JPTA related capabilities can be supported by the RU if RU informs an tx-array or rx-array is an JPTA array through M-plane. For backward compatibility, if the RU 1004 does not inform the type of the array, the DU 1002 expects RU 1004 to have a non-JPTA array.
   The RU 1004 informs the type of an tx-array or rx-array as JPTA array or non-JPTA array as follows. The JPTA capability is per tx-array or rx-array. If the RU 1004 does not inform the type of the array, the DU 1002 is expecting RU to have a non-JPTA array.

```
grouping tx/rx-common-array-carrier-elements {
    ...
    leaf array-type {
      type enumerate {
        enmu standard-array (default)
        enmu JPTA-array
      }
  }
}
```

In an embodiment, the RU 1004 informs its BF capability of using weight-based dynamic beamforming (WDBF).
   In an alternative, RU 1004 indicates the JPTA frontend architecture through the M-plane to the DU 1002. The JPTA frontend architecture including tx-array and rx-array architecture and configuration, and also the delay unit architecture and configuration.
      The provided M-plane capability report of JPTA frontend architecture is discussed in one or more embodiments herein.
         As an extension to one or more embodiments described herein, the DU 1002 may configure virtual delay unit architecture to RU 1004. This extension is demonstrated in one or more embodiments described herein.
In another embodiment, the RU 1004 informs its BF capability of using pre-defined beam beamforming (PDBF).
   In one alternative, the DU 1002 configures JPTA beamId to the RU 1004 through the C-plane. The JPTA beamId corresponds to a wideband with frequency-dependent beams towards different directions. RU 1004 indicates the pre-defined JPTA beamId and characteristics through the M-plane.
      The disclosure of M-plane capability report of this alternative is in one or more embodiments described herein.
   In another alternative, RU 1004 has the capability of computing the JPTA BF weights. Transparently from the DU 1002, the BF weights are computed based on the DU C-plane beamId configuration for the subbands. In this alternative, the DU 1002 configures beamId to the RU 1004 in each subband (SB) through the C-plane. The RU 1004 indicates the JPTA beam restriction to the DU through M-plane.
   The disclosure of M-plane capability report of this alternative is in one or more embodiments described herein.
In another embodiment, the RU 1004 informs its BF capability of using attribute-based dynamic beamforming (ADBF)
   In an alternative, RU 1004 has the capability of computing the JPTA BF weights. Transparently from the DU 1002, the BF weights are computed based on the DU C-plane beam attributes configuration for the subbands. In this alternative, the DU 1002 uses beam attributes configures to the RU 1004 for each subband (SB) through the C-plane. RU 1004 indicates the pre-defined JPTA beamId and characteristics through the M-plane.
      The disclosure of M-plane capability report of this alternative is in one or more embodiments described herein.
   The fronthaul interface 1006 allows communication between a RU 1004 and a DU 1002. In some embodiments, the fronthaul utilizes components such as a controller/processor, transceiver, and/or a memory. For example, the fronthaul interface may utilize components such as the controller/processor 225, transceivers 210a-210n, and memory 230. The fronthaul interface 1006 connects these components using wired or wireless technologies, such as optical fiber, Ethernet, or wireless links like millimeter-wave or sub-6 GHz frequencies. The fronthaul interface 1006 supports the transmission of baseband signals processed by the controller/processor 225, which handles advanced functions such as beamforming, directional routing, and RU JPTA capability in O-RAN fronthaul. The fronthaul interface 1006 can include components like optical transceivers, ethernet ports, or wireless transceivers (e.g., such as those in the gNB 102) and can operate in various setups, from large macro base stations to small cells, distributed antenna systems (DAS), and cloud-based radio networks (C-RAN). Advanced features of the fronthaul interface 1006 include dynamic bandwidth allocation, multi-protocol support (e.g., CPRI, eCPRI, or proprietary protocols), and energy-efficient mechanisms like adaptive power control.

In some embodiments, the fronthaul interface 1006 may be configured to transmit information indicating support for JPTA beamforming for the RU 1004 to a DU 1002 via a M-plane. In some embodiments, the fronthaul interface 1006 may be configured to transmit beamforming capability information associated with a frontend architecture of a transceiver of the RU 1004 to the DU 1002. In some embodiments, the fronthaul interface may be configured to receive a JPTA configuration based on the beamforming capability information from the DU 1002.

FIG. 11 illustrates a diagram of an example fronthaul signaling 1100 according to embodiments of the present disclosure. For example, fronthaul signaling 1100 may be signaled by the BS 103 of FIG. 1. This example is for illustration only and other embodiments can be used without departing from the scope of the present disclosure.

In this embodiment, the RU 1004 indicates the JPTA frontend architecture through the M-plane to the DU 1002. The JPTA frontend architecture including tx-array and rx-array architecture and configuration, and also the delay unit architecture and configuration. In the C-plane, the DU uses WDBF that configures per delay unit value and per phase-shifter (PS) value to the RU 1004.
In an example, with reference to FIG. 11, the RU 1004 reports JPTA frontend architecture related configuration to the DU 1002, including delay units to AE mapping, and the mapping of PS and delay unit value configuration bits in the C-plane to value mapping are shown. In the C-plane, the DU 1002 can transmit a delay vector including per delay unit value configuration and a phase vector including per PS value configuration. The delay vector and phase vector are included in section extension-1 (SE-1) attached to section type-1 (ST-1) for example.
   In an example, the delay vector and phase vector are included in section extension-1 (SE-1) attached to section type-1 (ST-1).
   In another example, the delay vector and phase vector are coupled to the beamId in the ST-1 by both DU 1002 and RU 1004. Both DU 1002 and RU 1004 can reuse beamId coupled with delay vector and phase vector in other C-plane configurations.

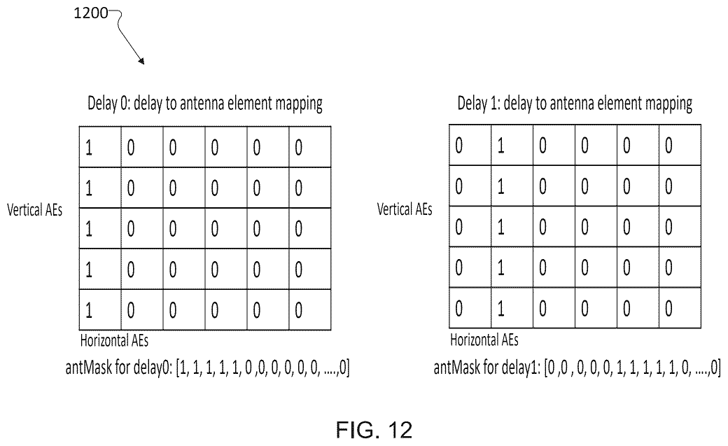

FIG. 12 illustrates tables of example delay units 1200 for horizontal and vertical antenna elements (AEs) according to embodiments of the present disclosure. For example, delay units 1200 (e.g., TD units) for horizontal and vertical antenna elements may be utilized by the gNB 102 of FIG. 1. This example is for illustration only and other embodiments can be used without departing from the scope of the present disclosure.

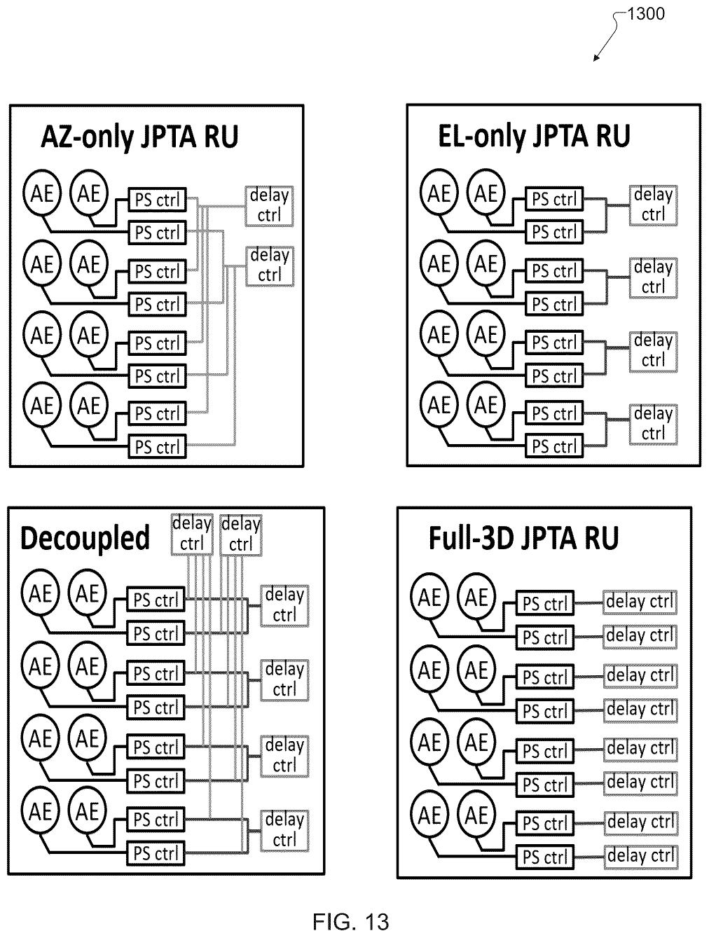

FIG. 13 illustrates diagrams of example JPTA frontend architectures 1300 according to embodiments of the present disclosure. For example, JPTA frontend architectures 1300 can be implemented in the transceivers and antennas of the gNB 102 of FIG. 2. This example is for illustration only and other embodiments can be used without departing from the scope of the present disclosure.

In an embodiment, the RU 1004 indicates delay unit to AE mapping to the DU 1002 through the M-plane. For example, the frontend architecture 1300 of the RU 1004 includes AEs, phase (PS) control elements, and TD control elements that affect the capabilities of the RU 1004 to perform beamforming, particularly JPTA beam forming, including, for example, without limitations, which beams can be transmitted, horizontal and/or vertical angles of beams, capabilities for simultaneous beam transmission, etc. The manner in which these AEs, PS control elements, and TD control elements, e.g., quantity PS control elements and/or TD control elements per AE, are connected affects the JPTA beamforming capabilities of the RU 1004.
In an alternative, the JPTA RU 1004 reports the delay unit to AE mapping to the DU 1002.
In another alternative, the JPTA RU 1004 is conditional-mandatory to report the delay unit to AE mapping to the DU 1002.
   In an example, the condition is satisfied when the RU 1004 supports WDBF.
   In another example, the condition is satisfied when the RU 1004 supports WDBF and configured as using WDBF by the DU 1002.
In an embodiment, the RU 1004 indicates delay unit to AE mapping using a standardized format.
   In an alternative, the delay unit to AE mapping is formatted as a bit mask.
      In an example, the RU 1004 reports a bit mask for each delay unit. The bit mask, for example named “antMask”, contains K bits, where K is the number of AE in array. The k-th bit indicates the connection relationship of the delay unit to the k-th AE in the array.
         With reference to FIG. 12, the antenna array has 5 AE in vertical, 6 AE in horizontal, and single polarization. The AE are indexed starting from the left-bottom to the left-top, then from the left to the right. The delay unit 0 to AE mapping is shown on the left, in which bit value 1 means connected; bit value 0 means not connected. The delay unit 0 is connected to the left column of AEs. The antMask for delay unit 0 is a 5×6=30 bits vector, the first to fifth bits are 1 and others are 0. The delay unit 1 to AE mapping is shown on the right, in which bit value 1 means connected; bit value 0 means not connected. The delay unit 0 is connected to the second from left column of AEs. The antMask for delay unit 1 is a 5×6=30 bits vector, the first to fifth bits are 0, sixth to tenth bits are 1, and others are 0.

In some embodiments, the DU scheduling is a function of the exact architecture. In some embodiments, the DU JPTA BF weight computation is based on the exact architecture. In some embodiments, the C-plane BF configures the format (ex. # of delay units in the message).

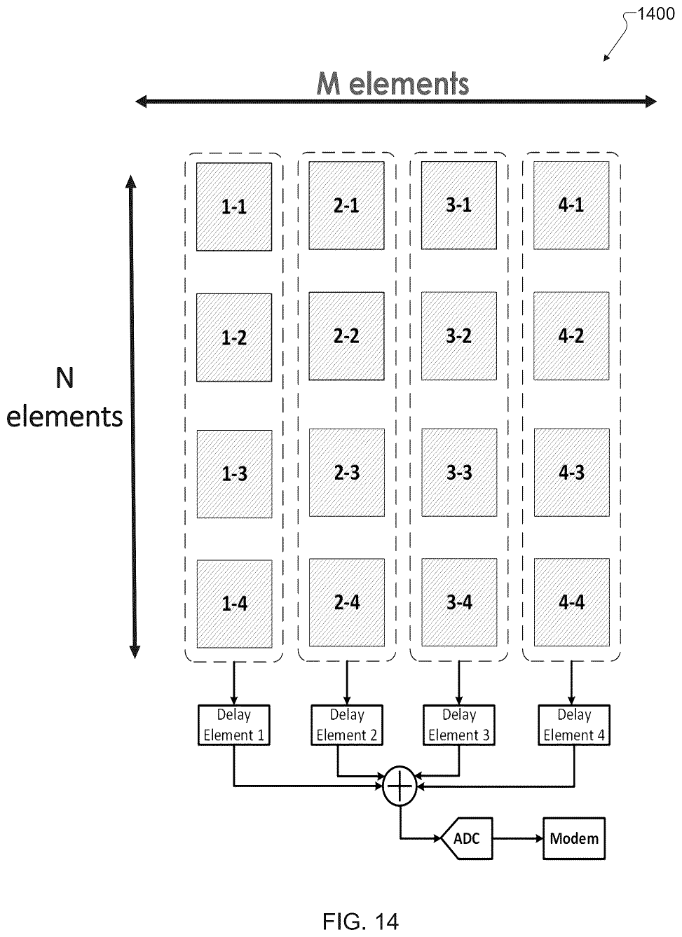

FIG. 14 illustrates a diagram of an example azimuth only JPTA architecture 1400 according to embodiments of the present disclosure. For example, azimuth only JPTA architecture 1400 can be implemented by the gNB 103 of FIG. 1. This example is for illustration only and other embodiments can be used without departing from the scope of the present disclosure.

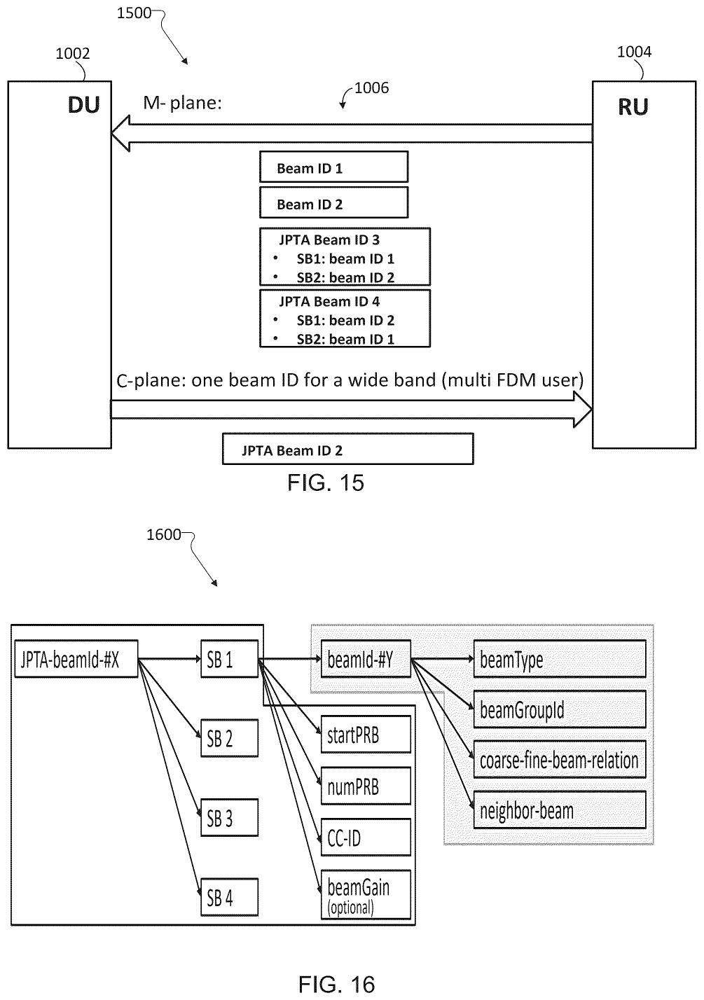

FIG. 15 illustrates a diagram of an example fronthaul signaling 1500 according to embodiments of the present disclosure. For example, fronthaul signaling 1400 may be signaled by the BS 102 of FIG. 1. This example is for illustration only and other embodiments can be used without departing from the scope of the present disclosure.

FIG. 16 illustrates a diagram of an example JPTA beam ID 1600 according to embodiments of the present disclosure. For example, JPTA beam ID 1600 may be configured by the BS 102 of FIG. 2. This example is for illustration only and other embodiments can be used without departing from the scope of the present disclosure.

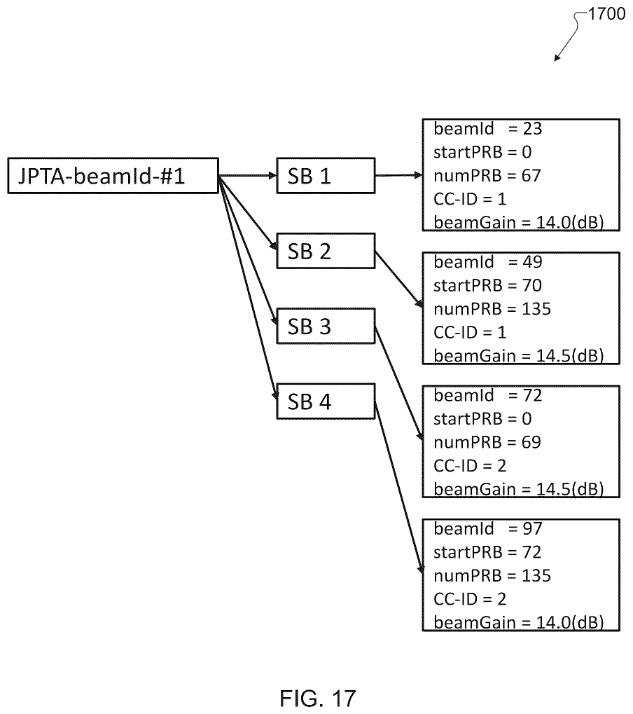

FIG. 17 illustrates a diagram of an example JPTA beam ID 1700 according to embodiments of the present disclosure. For example, JPTA beam ID 1700 can be configured by the BS 103 of FIG. 1. This example is for illustration only and other embodiments can be used without departing from the scope of the present disclosure.

In this embodiment, the DU 1002 configures JPTA beamId to the RU 1004 through the C-plane. The JPTA beamId corresponds to a wideband with frequency-dependent beams towards different directions. RU indicates the pre-defined JPTA beamId and characteristics through the M-plane.

In an embodiment, JPTA-beamId is introduced upon the beamId. The beamId is associated to beam characteristic including beamType, beamGroupId, coarse-fin-beam-relation, and neighbor-beam. The JPTA-beamId includes one or multiple subband information. For each subband, a beamId is attached and other subband related configurations. In the M-plane, with reference to FIG. 15, the beamId and JPTA-beamId are reported by the RU 1004 to the DU 1002. In the C-plane, the DU 1004 can configure JPTA-beamId to the RU 1004 for PDBF configuration.

With reference to FIG. 16, in an example, the JPTA-beamId definition is shown. The JPTA-beamId contains one or multiple subband fields. Each subband field contains a beamId, the starting physical resource block (PRB) index (startPRB), the number of PRB in the subband (numPRB), carrier component index (CC-ID) and optionally the gain of the beam in the subband (beamGain). An example model is shown below:

```
grouping jpta-beam-identifier {
    leaf jptaBeamId {
            type uint {
                range “0..65535”
                description
              “Identification number for a JPTA beam”;}
    list jptaSubband{
          key id;
          leaf id{
              type uint {
                  range “0..max”;}
              description
              “Identification number for subband of JPTA beams”;
          leaf beamId{
              type int {
                  range “0..65535”}
              description
              “ Identification number for a beam.”;}
          leaf startPRB{
              type uint {
                  range “0..max”; }
              description
              “The index of the first PRB in the subband.”;}
        leaf numPRB{
              type uint {
                  range “0..max”; }
              description
              “The number of PRBs in the subband.”;}
      leaf CC-ID{
              type uint {
                  range “0..max”; }
              description
              “The carrier component index.”;}
        leaf beamGain{
              type decimal64 {
                  fraction-digits 4; }
              units dB;
              default 0;
              description
              “The gain correction of subband beams”;}
  }
}
```

FIG. 18 illustrates a diagram of an example fronthaul signaling 1800 according to embodiments of the present disclosure. For example, fronthaul signaling 1800 may be signaled between the DU 1002 and RU 1004 in a BS, such as BS 102 of FIG. 2. This example is for illustration only and other embodiments can be used without departing from the scope of the present disclosure.

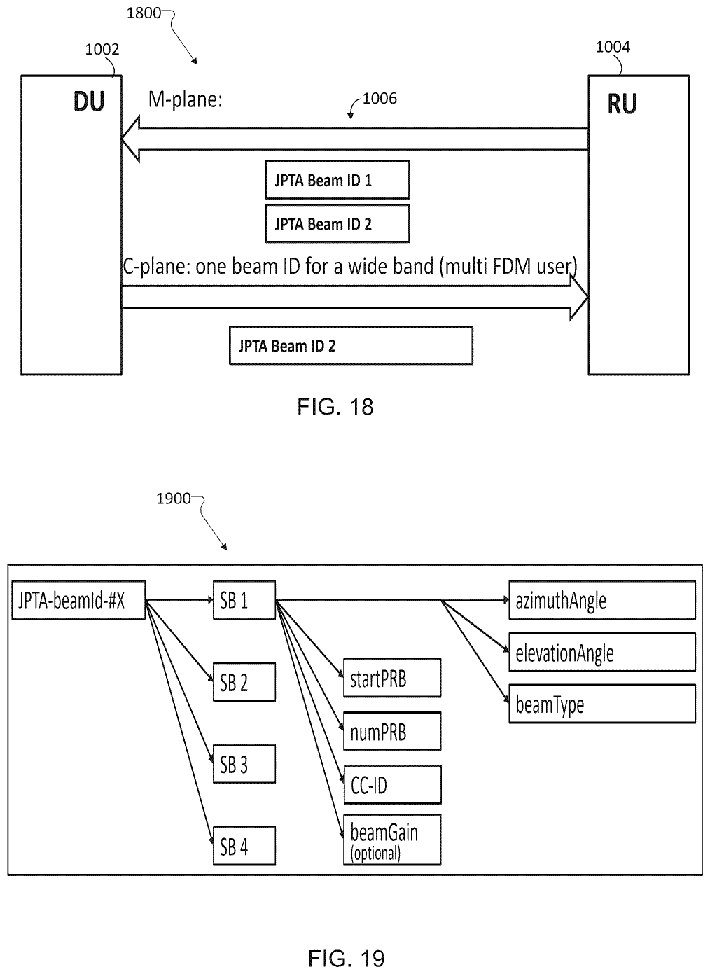

FIG. 19 illustrates a diagram of an example JPTA beam ID 1900 according to embodiments of the present disclosure. For example, JPTA beam ID 1900 may be utilized by the DU 1002 and RU 1004 in a BS, such as BS 102 of FIG. 2. This example is for illustration only and other embodiments can be used without departing from the scope of the present disclosure.

In an embodiment, JPTA-beamId is newly defined delicately for JPTA RU. The JPTA-beamId include one or multiple subband information. For each subband, the beam characteristics and subband related configurations are included. In the M-plane, with reference to FIG. 18, the JPTA-beamIds are reported by the RU to the DU. In the C-plane, the DU can configure JPTA-beamId to the RU 1004 for PDBF configuration.
In an example with reference to FIG. 19, the JPTA-beamId definition is shown. The JPTA-beamId contains one or multiple subband fields. Each subband field contains the beam characteristic, for example the direction of the beam (azimuth angle and elevation angle) and the width of the beam (beamType follows the definition used in beamId), the starting PRB index (startPRB), the number of PRB in the subband (numPRB), carrier component index (CC-ID) and optionally the gain of the beam in the subband (beamGain). An example of model is shown herein.

```
grouping jpta-beam-identifier {
    leaf jptaBeamId {
          type uint {
              range “0..65535”
              description
            “Identification number for a JPTA beam”;}
    list jptaSubband{
        key id;
        leaf id{
            type uint {
                range “0..max”;}
            description
            “Identification number for subband of JPTA beams”;
        leaf azimuthAngle{
            type int {
                range “−180..179”; }
            description
            “The azimuth angle of the beam in the subband.”;}
        leaf elevationAngle{
            type uint {
                range “0..90”; }
            description
            “ The azimuth angle of the beam in the subband.”;}
        leaf beam-type{
            type enumeration{
                enum COARSE-BEAM {description “Coarse beam.”;}
                enum FINE-BEAM {description “Fine beam.”;}}
            description
            “The relative width relationship of the subband beams”;}
        leaf startPRB{
            type uint {
                range “0..max”; }
            description
            “The index of the first PRB in the subband.”;}
      leaf numPRB{
            type uint {
                range “0..max”; }
            description
            “The number of PRBs in the subband.”;}
      leaf CC-ID{
            type uint {
                range “0..max”; }
            description
            “The carrier component index.”;}
      leaf beamGain{
            type decimal64 {
                fraction-digits 4; }
            units dB;
            default 0;
            description
            “The gain correction of subband beams”;}
  }
}
```

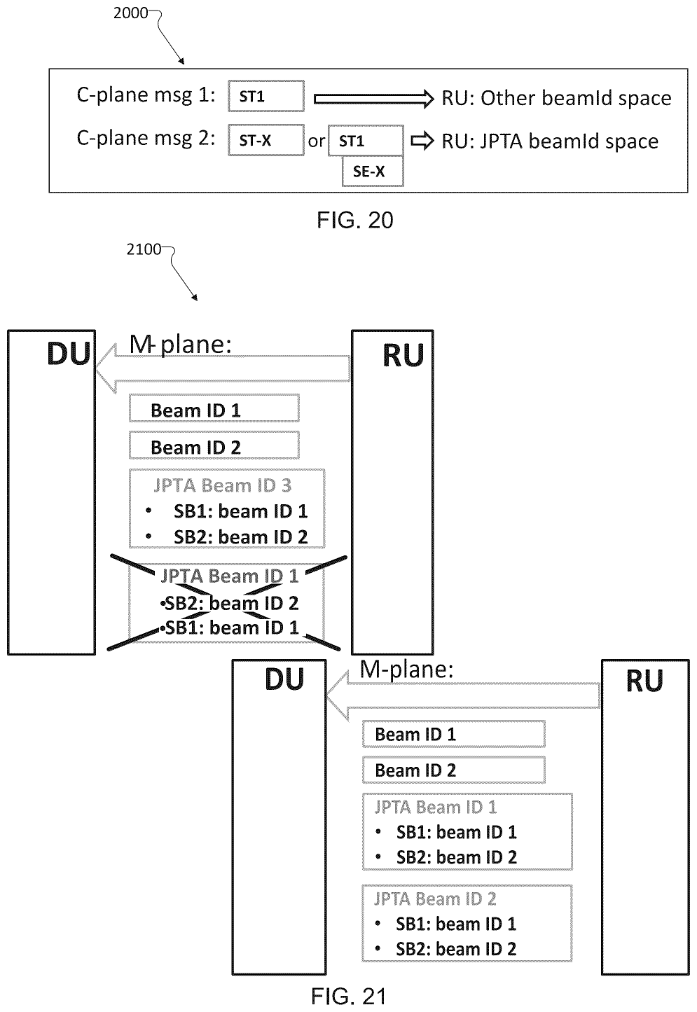

FIG. 20 illustrates a diagram of an example beam ID space indication 2000 according to embodiments of the present disclosure. For example, beam ID space indication 2000 may be indicated between the DU 1002 and RU 1004 in a BS, such as BS 102 of FIG. 2. This example is for illustration only and other embodiments can be used without departing from the scope of the present disclosure.

FIG. 21 illustrates diagrams of example fronthaul signaling 2100 according to embodiments of the present disclosure. For example, fronthaul signaling 2100 may be signaled between the DU 1002 and RU 1004 in a BS, such as BS 102 of FIG. 2. This example is for illustration only and other embodiments can be used without departing from the scope of the present disclosure.

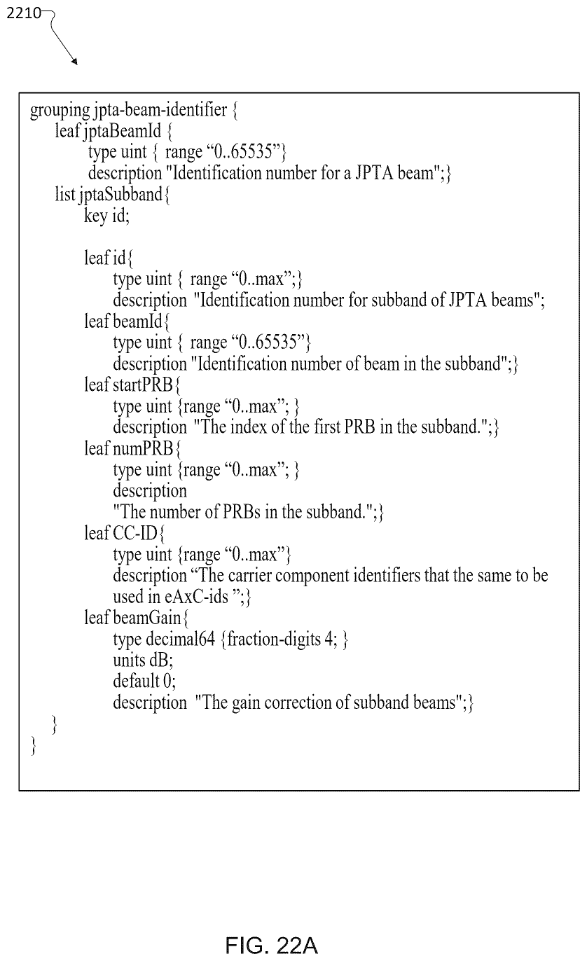

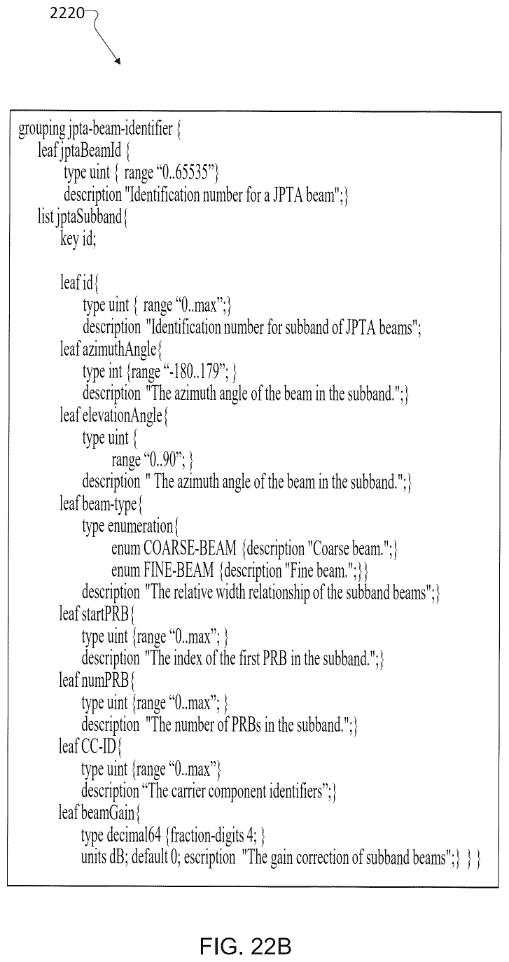

FIGS. 22A and 22B illustrate examples of JPTA beam IDs 2210 and 2220 according to embodiments of the present disclosure. For example, JPTA beam IDs 2210 and 2220 may be signaled between the DU 1002 and RU 1004 in a BS, such as BS 102 of FIG. 2. This example is for illustration only and other embodiments can be used without departing from the scope of the present disclosure.

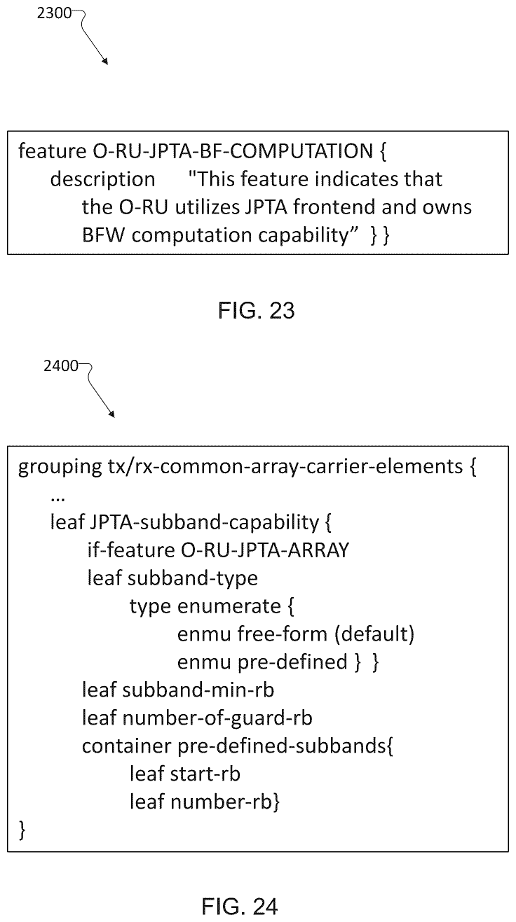

FIG. 23 illustrates a diagram of an example JPTA indication 2300 according to embodiments of the present disclosure. For example, JPTA indication 2300 may be indicated by the DU 1002 to the RU 1004 in a BS, such as BS 102 of FIG. 2. This example is for illustration only and other embodiments can be used without departing from the scope of the present disclosure.

FIG. 24 illustrates a diagram of an example JPTA indication 2400 according to embodiments of the present disclosure. For example, JPTA indication 2400 may be indicated by the DU 1002 to the RU 1004 in a BS, such as BS 102 of FIG. 2. This example is for illustration only and other embodiments can be used without departing from the scope of the present disclosure.
In an embodiment, a RU 1004 indicates JPTA BFW computation capability through an M-plane
In am embodiment, a RU 1004 indicates JPTA beam restrictions, e.g., restriction of SB including JPTA SB capability. A type of JPTA SB is free-form SB which includes Guard band in # of PRB, Minimum # of PRB per SB, and Max number of SB/beams/directions. IN one example, the RU 1004 reports the values. In another example, the DU can calculate the max number of beams based on max-delay. Another type of JPTA SB is pre-defined SB, e.g., StartPRB and numPRB for each SB. With reference to FIG. 24, M-plane indication through a model is shown.
In an embodiment, the JPTA beamId and beamId are in the same beamId space. Thus, the JPTA beamId and beamId are distinguished through beamId value. It is not expected that the RU 1004 reports a JPTA beamId and beamId that with the same beamId value. The DU 1002 is capable to distinguish and configure the JPTA beamId and/or beamId correctly through C-plane. The RY is capable to distinguish a beam is JPTA beamId or beamId by beamId value.
   In an example, the RU 1004 reports beamId in range 1 to 32767 and JPTA beamId in range 32768 to 65535.
   In another example, the RU 1004 reports beamId with odd value and JPTA beamId with even value.
In another embodiment, the JPTA beamId and beamId are in the different beamId space. The JPTA beamId and beamId can have the same beamId value.
   In one alternative, the beamId space that will be used in the C-plane is configured by the DU through M-plane.
      In an example, the DU 1002 configures the RU 1004 in a model as discussed herein:

```
grouping beamforming-parameters {
  ...
  leaf beamIdSpace {
      type enumeration {
        enmu JPTA-BEAM-ID;
        enmu BEAM-ID; }
      default: BEAM-ID
      description “Identification of beamId space.”;}
    }
}
```

In another alternative, the beamId space is indicated through the C-plane.
   In an example, the 1 or more bits are used in the C-plane message indicates the beamId space. For example, TABLE 1 ST1 with beamId space indication introduces a new field, beamIdSpace, in ST1, 0 refers to beamId space, and 1 refers to JPTA beamId space.

TABLE 1
ST1 with beamId space indication
Section Type 1: DL/UL control msgs

| | | | | | | | | # of |
|---|---|---|---|---|---|---|---|---|
| 0 (msb) | 1 | 2 | 3 | 4 | 5 | 6 | 7 (lsb) | bytes |

| transport header, see clause 5.1.3 | | | 8 | Octet 1 |
|---|---|---|---|---|
| dataDirection | payloadVersion | filterIndex | 1 | Octet 9 |

| frameId | | 1 | Octet 10 |
|---|---|---|---|
| subframeId | slotId | 1 | Octet 11 |

| | | | |
|---|---|---|---|
| slotId | startSymbolId | 1 | Octet 12 |

| numberOfsections | | | | 1 | Octet 13 |
|---|---|---|---|---|---|
| sectionType = 1 | | | | 1 | Octet 14 |
| udCompHdr | | | | 1 | Octet 15 |
| reserved | | | beamIdSpace | 1 | Octet 16 |
| sectionId | | | | 1 | Octet 17 |
| sectionId | rb | symInc | startPrbc | 1 | Octet 18 |

| startPrbc | | 1 | Octet 19 |
|---|---|---|---|
| numPrbc | | 1 | Octet 20 |
| reMask[11:4] | | 1 | Octet 21 |
| reMask[3:0] | numSymbol | 1 | Octet 22 |

| | | | |
|---|---|---|---|
| ef = 1 | beamId[14:8] | 1 | Octet 23 |

| beamId[7:0] | | | | 1 | Octet 24 |
|---|---|---|---|---|---|
| Section Extensions as indicated by “ef” | | | | var | Octet 25 |
| . . . | | | | | |
| sectionId | | | | 1 | Octet N |
| sectionId | rb | symInc | startPrbc | 1 | N + 1 |

| startPrbc | | 1 | N + 2 |
|---|---|---|---|
| numPrbc | | 1 | N + 3 |
| reMask[11:4] | | 1 | N + 4 |
| reMask[3:0] | numSymbol | 1 | N + 5 |

| | | | |
|---|---|---|---|
| ef = 0 | beamId[14:8] | 1 | N + 6 |

| | | |
|---|---|---|
| beamId[7:0] | 1 | N + 7 |
| Section Extensions as indicated by “ef” | var | N + 8 |

NOTE:
Shading: yellow is transport header, pink is radio application header, others are repeated sections

In another example, a new section type (ST), for example ST-X, is used for JPTA beamId configuration. In an example, ST-X has the same format as ST1, but different ST identifier (sectionType=X). If the RU revives ST1 through C-plane, the RU uses the beamId space. If the RU receives ST-X, the RU uses the JPTA beamId space.

TABLE 2
ST-X with JPTA beamId configuration
Section Type X: DL/UL control msgs for JPTA array

| | | | | | | | | # of |
|---|---|---|---|---|---|---|---|---|
| 0 (msb) | 1 | 2 | 3 | 4 | 5 | 6 | 7 (lsb) | byte |

| transport header, see clause 5.1.3 | | | 8 | Octet 1 |
|---|---|---|---|---|
| dataDirection | payloadVersion | filterIndex | 1 | Octet 9 |

| frameId | | 1 | Octet 10 |
|---|---|---|---|
| subframeId | slotId | 1 | Octet 11 |

| | | | |
|---|---|---|---|
| slotId | startSymbolId | 1 | Octet 12 |

| numberOfsections | | | | 1 | Octet 13 |
|---|---|---|---|---|---|
| sectionType = X | | | | 1 | Octet 14 |
| udCompHdr | | | | 1 | Octet 15 |
| reserved | | | | 1 | Octet 16 |
| sectionId | | | | 1 | Octet 17 |
| sectionId | rb | symInc | startPrbc | 1 | Octet 18 |

| startPrbc | | 1 | Octet 19 |
|---|---|---|---|
| numPrbc | | 1 | Octet 20 |
| reMask[11:4] | | 1 | Octet 21 |
| reMask[3:0] | numSymbol | 1 | Octet 22 |

| | | | |
|---|---|---|---|
| ef = 1 | beamId[14:8] | 1 | Octet 23 |

| beamId[7:0] | | | | 1 | Octet 24 |
|---|---|---|---|---|---|
| Section Extensions as indicated by “ef” | | | | var | Octet 25 |
| . . . | | | | | |
| sectionId | | | | 1 | Octet N |
| sectionId | rb | symInc | startPrbc | 1 | N + 1 |

| startPrbc | | 1 | N + 2 |
|---|---|---|---|
| numPrbc | | 1 | N + 3 |
| reMask[11:4] | | 1 | N + 4 |
| reMask[3:0] | numSymbol | 1 | N + 5 |

| | | | |
|---|---|---|---|
| ef = 0 | JPTA-beamId[14:8] | 1 | N + 6 |

| | | |
|---|---|---|
| JPTA-beamId[7:0] | 1 | N + 7 |
| Section Extensions as indicated by “ef” | var | N + 8 |

NOTE:
Shading: yellow is transport header, pink is radio application header, others are repeated sections

In another example, a new section extension (SE), for example SE-X, containing a beamId space indication. If the RU 1004 revives SE-X with ST1 through the C-plane, and the beamIdSpace is set as 1, the RU 1004 uses the JPTA beamId space. Otherwise, the RU 1004 receives ST-X, the RU uses the beamId space.

TABLE 3
Format of Section Extension X

| | | | | | | | | # of |
|---|---|---|---|---|---|---|---|---|
| 0 (msb) | 1 | 2 | 3 | 4 | 5 | 6 | 7 (lsb) | bytes |

| | | | |
|---|---|---|---|
| ef | extType = 0x0X | 1 | Octet N |

| | | |
|---|---|---|
| extLen = 1 | 1 | Octet |
| | | N + 1 |
| beamIdSpace | 1 | Octet |
| | | N + 2 |
| reserved | 1 | Octet |
| | | N + 3 |
| zero pad to 4-byte boundary | var | |

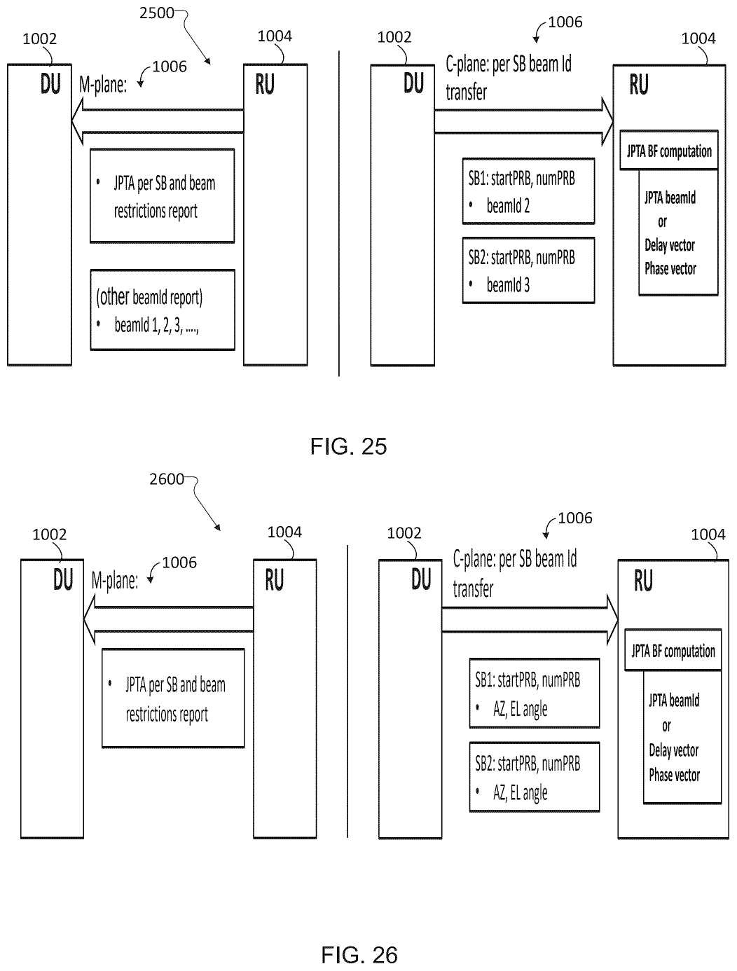

FIG. 25 illustrates diagrams of example fronthaul signaling 2500 according to embodiments of the present disclosure. For example, fronthaul signaling 2500 may be signaled between the DU 1002 and RU 1004 in a BS, such as BS 102 of FIG. 2. This example is for illustration only and other embodiments can be used without departing from the scope of the present disclosure.

FIG. 26 illustrates diagrams of example fronthaul signaling 2600 according to embodiments of the present disclosure. For example, fronthaul signaling 2600 may be signaled between the DU 1002 and RU 1004 in a BS, such as BS 102 of FIG. 2. This example is for illustration only and other embodiments can be used without departing from the scope of the present disclosure.

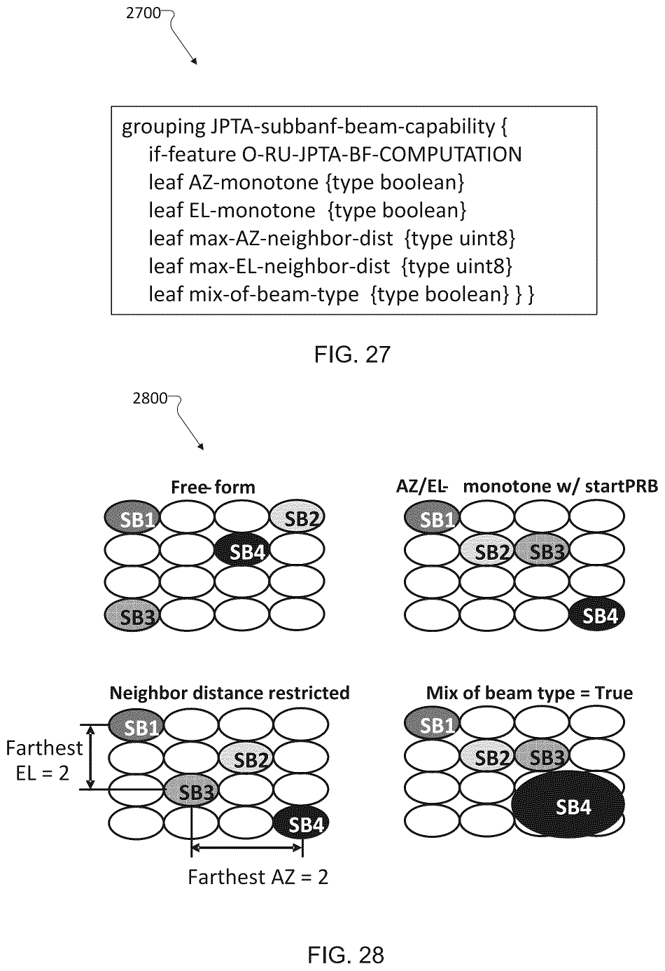

FIG. 27 illustrates a diagram of an example JPTA indication 2700 according to embodiments of the present disclosure. For example, JPTA indication 2700 may be signaled between the DU 1002 and RU 1004 in a BS, such as BS 102 of FIG. 2. This example is for illustration only and other embodiments can be used without departing from the scope of the present disclosure.

In this embodiment, the RU 1004 has the capability of computing the JPTA BF weights. For example, the RU indicates such feature through M-plane.

```
feature O-RU-JPTA-BF-COMPUTATION {
  description “This feature indicates that the O-RU utilizes JPTA frontend and owns
    BFW computation capability”}
}
```

Transparently from the DU, the BF weights are computed based on the DU C-plane configuration. The RU 1004 indicates the JPTA beam restriction to the DU through M-plane.
In PDBF, with reference to FIG. 25, an example is shown. The RU 1004 indicates the beamId and JPTA beam restriction to the DU 1002 through M-plane. The DU 1002 configures beamId for the subbands through the C-plane.
In ADBF, with reference to FIG. 26, an example is shown. The RU 1004 indicates the JPTA beam restriction to the DU 1002 through M-plane. The DU configures beam attributes for the subbands through the C-plane.
In an embodiment, the RU 1004 supports pre-defined subband configuration. The DU 1002 can only configure physical resource within the PRB range of the pre-defined subbands.
   In an example, the RU 1004 indicates the subband capability, for example as “PRE-DEFINED”. The RU 1004 also indicates the pre-defined subband information, including startPRB, numPRB.
In an embodiment, the RU 1004 supports free-from subband that is not pre-defined by the RU but may restricted to be configured as any PRB range by the DU 1002.
   In an example, the RU 1004 indicates the subband capability, for example as “FREE-FORM”. The RU also indicates the free-from subband restriction information, for example, the minimum guard band size, the minimum PRB or subcarriers in between two minimum guard bands, the maximum number of the frequency dependent beams. For the indication of the maximum number of the frequency dependent beams:
      In an alternative, the RU 1004 reports the maximum supported number of the frequency dependent beams.
      In another alternative, the RU 1004 does not report such information to the DU 1002. The DU infers from the JPTA architecture and the maximum supported delay values.
An example model is shown herein about the two embodiments herein.
   In an embodiment, the RU 1004 reports subband capability only when the RU 1004 has JPTA BF weights computation capability. For example, the RU 1004 reports O-RU-JPTA-BF-COMPUTATION feature.
   In another embodiment, the RU 1004 reports subband capability when the RU 1004 has an JPTA frontend. For example, the RU 1004 reports O-RU-JPTA-ARRAY feature.

```
  grouping tx/rx-common-array-carrier-elements {
  ...
  leaf JPTA-subband-capability{
      if-feature O-RU-JPTA-ARRAY or O-RU-JPTA-BF-COMPUTATION
      leaf subband-type{
          type enumeration {
                enum PRE-DEFINED
              {description “RU supports pre-defined subband.”;}
                enum FREE-FORM
              {description “ RU follows DU C-plane subband configuration.”;}
            }
          description
          “Indication of RU subband capability”;}
      leaf subband-min-rb{
          type uint {
                range “0..max”; }
          description
          “The minimum number of PRB for one subband.”;}
    leaf number-of-guard-rb{
          type uint {
                range “0..max”; }
          description
          “The minimum number of guard PRBs between the subbands.”;}
    container pre-defined-subbands{
          leaf start-rb{
              type uint {
                  range “0..max”; }
              description
              “The index of the first PRB in the subband.”;}
        leaf number-rb {
              type uint {
                  range “0..max”; }
              description
              “The number of PRBs in the subband.”;}
          description:
          “The RU pre-defined subband.”;}
  }
}
```

FIG. 28 illustrates diagrams of example subbands configurations 2800 according to embodiments of the present disclosure. For example, subbands configurations 2800 can be configured by the BS 102 of FIG. 1. This example is for illustration only and other embodiments can be used without departing from the scope of the present disclosure.
In an embodiment, the free-from per SB beam has no beam restriction. In an embodiment, the restricted beam and restriction indication is through the M-plane. For example, AZ/EL-is increasing w/PRB index. For example, the neighbor distance is restricted to the farthest-neighbor in AZ/EL, e.g., set as 0 for AZ/EL-only JPTA in ADBF. The mix of beam types (coarse or fine beam) can be true or false. For PDBF, if the field is true, the DU can configure fine and coarse beams in the same OFDM symbol (OS) but different SB. For ADBF, if this field is True, the DU can config beam width to RU.
In an embodiment, the RU 1004 does not have any restriction on per subband beams (free-from), for example, the DU can configure any beamId or any beam attribute in each subband. With reference to FIG. 28, an example is shown in the top-left subfigure.
   In an alternative, the RU 1004 does not report any restriction to the DU 1002, and the DU 1002 expects RU 1004 supports free-from per subband beam.
   In another alternative, the RU 1004 reports restriction as embodiments herein, but provides a wide diversity for the DU to select beamId or beam attributes per subband.
In another embodiment, the RU 1004 has a requirement that for subbands with the increasing startPRB values, the elevation or azimuth angle of the beam in the subband is monotone. JPTA BF weights solution with monotone restriction requires less complexity than free-from. With reference to FIG. 28, an example is shown in the top-right subfigure.
   In an example of azimuth-monotone, in concatenate 4 subband, i.e., [SB1, SB2, SB3, SB4], the azimuth angle of the beam in the 4 subbands are [0, 10, 20, 30] or [0, −10, 10, −25] that monotonal non-increase or non-decrease.
   In an alternative, the RU 1004 indicates the azimuth-monotone and/or elevation-monotone restriction through M-plane. A Boolean field (leaf) of AZ-monotone and/or EL-monotone is included in the model.
In another embodiment, the RU 1004 has a restriction for the beam in the next subband that beam should within the F-th neighbor of the beam in the current subband. The neighbor beam is included in beamId description. For a targeted beam, whose 1^{st} neighbor defined as the beam within the neighbor-beam; whose 2^{nd} neighbor beams are defined as the 1^{st} neighbor beam of the 1^{st} neighbor beam of the targeted beam; whose F-th neighbor beam is the 1^{st} neighbor beam of the (F−1)-th neighbor beam of the targeted beam. With reference to FIG. 28, an example is shown in the bottom-left subfigure.
   In an alternative, the RU 1004 indicates capability of mixing the beam-type M-plane. A field (leaf) of farthest-neighbor-beam-in-next-subband is included in the model.
In another embodiment, the RU 1004 has a restriction to use a mix of coarse and fine beams. With reference to FIG. 28, an example is shown in the bottom-right subfigure.
   In an alternative, the RU 1004 indicates capability of mixing the beam-type M-plane. A Boolean field (leaf) of mix-of-beam-type is included in the model.

An example of M-plane JPTA beam restriction indication is shown herein:

```
grouping JPTA-subband-beam-capability {
  if-feature O-RU-JPTA-BF-COMPUTATION
  leaf AZ-monotone {
    type boolean
    description
    “If the azimuth angle of the beam is monotone with the subband startPRB.”;}
  leaf EL-monotone {
    type boolean
    description
    “ If the elevation angle of the beam is monotone with the subband startPRB ”;}
  leaf farthest-neighbor-beam-in-next-subband {
    type uint {
      range “0..max”; }
    description
    “The farthest neighbor beam supported in the concatenate subband.”;}
  leaf mix-of-beam-type {
    type boolean
    description
    “The minimum number of PRB for one subband.”;}
}
```

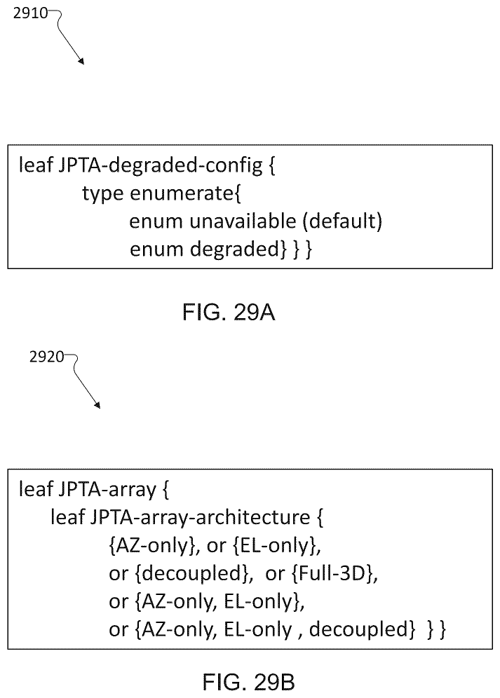

FIGS. 29A and 29B illustrate diagrams of example JPTA indications 2910 and 2920 according to embodiments of the present disclosure. For example, JPTA indications 2910 and 2920 may be indicated by the DU 1002 to the RU 1004 in a BS, such as BS 102 of FIG. 2. This example is for illustration only and other embodiments can be used without departing from the scope of the present disclosure.

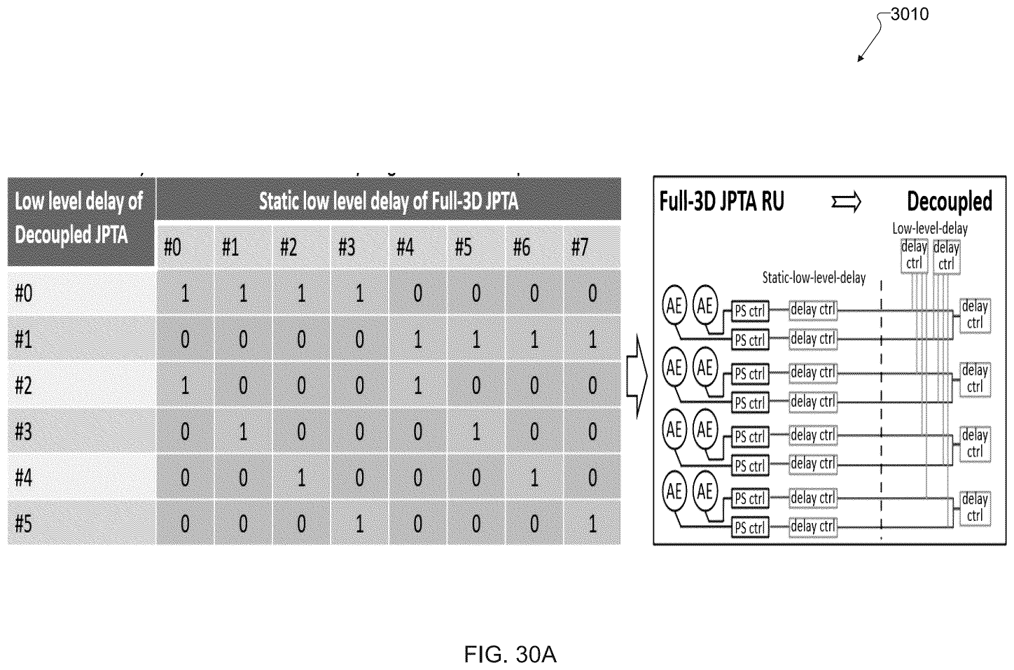

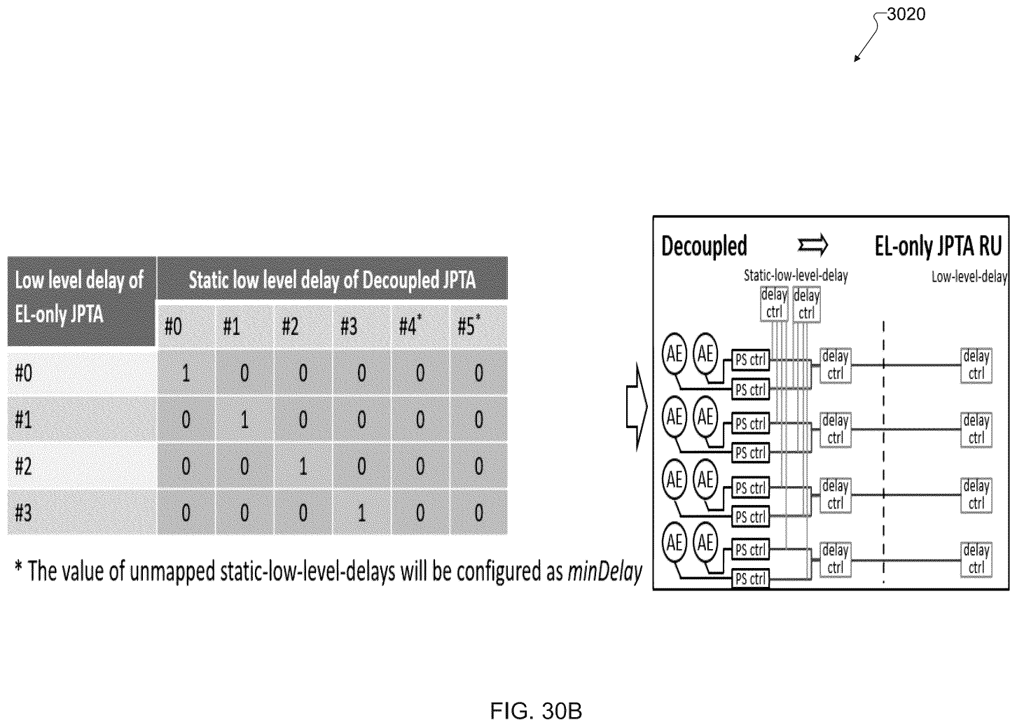

FIGS. 30A and 30B illustrate diagrams of example JPTA configurations 3010 and 3020 for RU frontend architectures according to embodiments of the present disclosure. For example, JPTA configurations 2910 and 2920 can be configured by the DU 1002 for the RU 1004 in a BS, such as BS 102 of FIG. 2. This example is for illustration only and other embodiments can be used without departing from the scope of the present disclosure.

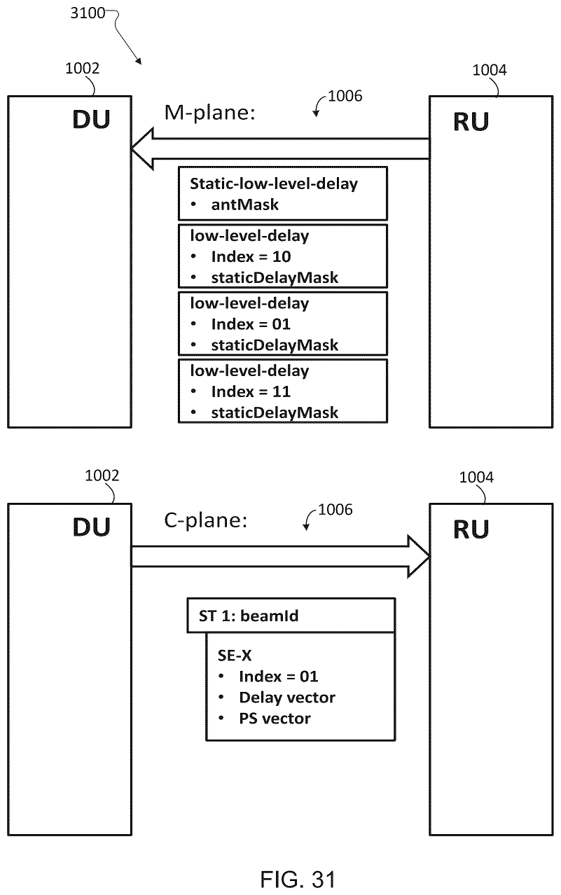

FIG. 31 illustrate diagrams of example fronthaul signaling 3100 according to embodiments of the present disclosure. For example, fronthaul signaling 3100 may be signaled between the DU 1002 and RU 1004 in a BS, such as BS 102 of FIG. 2. This example is for illustration only and other embodiments can be used without departing from the scope of the present disclosure.

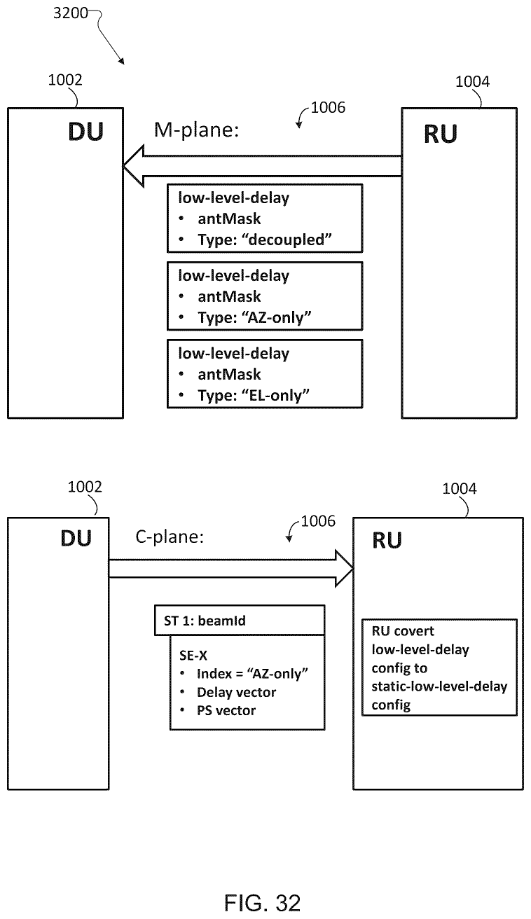

FIG. 32 illustrate diagrams of example fronthaul signaling 3200 according to embodiments of the present disclosure. For example, fronthaul signaling 3200 may be signaled between the DU 1002 and RU 1004 in a BS, such as BS 102 of FIG. 2. This example is for illustration only and other embodiments can be used without departing from the scope of the present disclosure.

In various embodiments, some RUs may support being configured in C-plane as a degraded JPTA-array. A baseline is DU config the unused delay value as 0 to RU in C-plane. The degradation may depend on DU JPTA computation capability or choice based on complexity, fronthaul bandwidth, etc. The depredation cannot be configured by replacing the antMask for delays, for example, the number of delay units to be configured is different.

In another embodiment, static JPTA array architecture with degradation is provided. With reference to FIG. 29A, the RU capability report of supporting degraded JPTA array is shown. DU config low-level-delays to static-low-level-delays mapping is through an additional static DelayMask. The DU is aware of the dynamic range of static-low-level-delay. With reference to FIGS. 30A and 30B, the staticDelayMask is shown.

In another embodiment, with reference to FIG. 29B, RU capability reports a list of the supported JPTA array architecture. For each in the list, the RU provides per supported type delay antMask. The number of delay may different in each JPTA array architecture. The static-low-level-delay is transparent to the DU. The DU selects one from the list through the M-plane.

Dynamic JPTA array architecture config through C-plane (flexibility improvement) is provided. In another embodiment, the RU reports static-low-level-delay antMask, and supported low-level-delay staticDelayMask, with index (Index=0 can refer to no-degradation). The DU selects one and indicate the index in C-plane. DU is aware of the dynamic range of static-low-level-delay. The RU will apply staticDelayMask and antMask if JPTA degradation is configured in C-plane. Otherwise, RU will apply the antMask for static-low-level-delay config. Note that index=00 means no degradation.

In another embodiment, the RU report one or multiple antMask for low-level-delay config. The # of delay can be different using different antMask. The static-low-level-delay is transparent to DU. To avoid overflow of static-low-level-delay (ex. “full-3D” degraded to “decoupled”), RU may report per antMask bit-vector to low-level-delay value mapping. The DU select one antMask, indicate the index in C-plane, and config the low-level-delay values. The RU will handle the static-low-level-delay config.

In another embodiment with reference to FIG. 30A, staticDelayMask for full-3D JPTA array is degraded to decoupled. In another embodiment with reference to FIG. 30B, static DelayMask for Decoupled JPTA array is degraded to EL-only. The value of unmapped static-low-level-delays will be configured as minDelay.

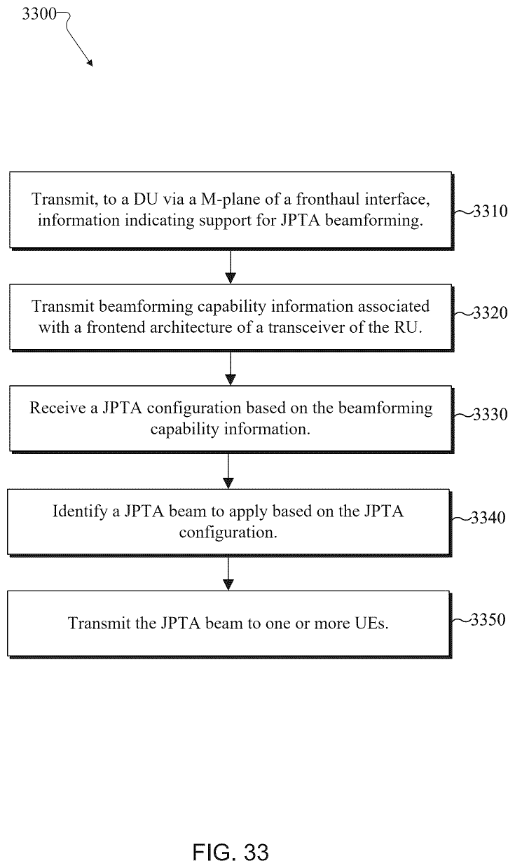

FIG. 33 illustrates an example method 3300 performed by an RU in a wireless communication system according to embodiments of the present disclosure. The method 3300 of FIG. 33 can be performed by the RU 1004, and a corresponding method can be performed by the DU 1002, in the BS 102 of FIG. 2. The method 3300 is for illustration only and other embodiments can be used without departing from the scope of the present disclosure.

The method 3300 begins with the RU 1004 transmitting information indicating support for JPTA beamforming (3310). For example, in 3310, the information may be as simple as a flag or may include additional information. The information may be transmitted to the DU 1002 via the M-plane of the fronthaul interface 1006. The RU 1004 then transmits, to the DU, beamforming capability information associated with a frontend architecture of a transceiver of the RU (3320).

The RU 1004 then receives, from the DU 1002, a JPTA configuration based on the beamforming capability information (3330). The RU 1004 then identifies a JPTA beam to apply based on the JPTA configuration (3340). For one example, in 3340, the RU 1004 is informed, by the JPTA configuration of the DU's 1002 decision on JPTA beam when it is explicitly configured, e.g., for WDBF and PDBF with a JPTA beam ID. In other examples, the RU 1004 can determine the JPTA beam when DU 1002 does not explicitly configure which JPTA beam to use, e.g., the DU configures expected beam direction per subband and the RU 1004 determines the JPTA beam. The RU then transmits the JPTA beam to one or more UEs, (3350). For example, in 3350, the JPTA beam is that which was identified as discussed above.

In various embodiments, the beamforming capability information indicates a WDBF capability and includes information about a delay unit to AE mapping between AEs and delay units of the RU 1004, for example, as discussed with regard to FIG. 13 above. The information about the delay unit to AE mapping includes a plurality of bits, each bit in the plurality of bits indicates an association between one of the delay units and one of the AEs, and the JPTA configuration includes a delay vector and a phase vector.

In various embodiments, the beamforming capability information indicates a PDBF capability and includes JPTA beam IDs and SB beam IDs associated with one or more of the JPTA beam IDs. Each of the SB beam IDs indicate a beam ID, a starting PRB, a number of PRB, a carrier component identifier, and a beam gain. The JPTA configuration indicates a JPTA beam identifier from the JPTA beam IDs.

In various embodiments, the beamforming capability information indicates an ADBF capability and includes (i) information indicating a capability to compute JPTA beamforming weights and (ii) information indicating beam restrictions of the RU including supported subbands and a total number of JPTA beams. The JPTA configuration includes per subband beam identifiers. In some examples, the beam restrictions further indicate available azimuth and elevation angles across the supported subbands. In some example, the beam restrictions further indicate a capability to support a mix of coarse and fine beams.

In various embodiments, the beamforming capability information indicates a WDBF capability and includes a plurality of bits indicating a delay unit to AE mapping between AEs and delay units of the RU. The plurality of bits in the transmitted beamforming capability information are less than a number of bits needed to indicate a mapping between each of AE and delay unit of the RU.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A radio unit (RU), comprising:
a fronthaul interface configured to:
transmit, to a distributed unit (DU) via a management-plane (M-plane), information indicating support for joint phase-time array (JPTA) beamforming;
transmit, to the DU, beamforming capability information associated with a frontend architecture of a transceiver of the RU; and
receive, from the DU, a JPTA configuration based on the beamforming capability information;
a processor operably coupled with the fronthaul interface and the transceiver, the processor configured to identify a JPTA beam to apply based on the JPTA configuration; and
the transceiver configured to transmit, to one or more user equipment (UEs), the JPTA beam.

2. The RU of claim 1, wherein:
the beamforming capability information indicates a weight-based dynamic beamforming (WDBF) capability,
the beamforming capability information includes information about a delay unit to antenna element (AE) mapping between AEs and delay units of the RU,
the information about the delay unit to AE mapping includes a plurality of bits,
each bit in the plurality of bits indicates an association between one of the delay units and one of the AEs, and
the JPTA configuration includes a delay vector and a phase vector.

3. The RU of claim 1, wherein:
the beamforming capability information indicates a predefined beamforming (PDBF) capability,
the beamforming capability information includes JPTA beam identifiers (IDs) and subband (SB) beam IDs associated with one or more of the JPTA beam IDs,
each of the SB beam IDs indicate a beam ID, a starting physical resource block (PRB), a number of PRB, a carrier component identifier, and a beam gain, and
the JPTA configuration indicates a JPTA beam identifier from the JPTA beam IDs.

4. The RU of claim 1, wherein
the beamforming capability information indicates an attribute-based dynamic beamforming (ADBF) capability,
the beamforming capability information includes (i) information indicating a capability to compute JPTA beamforming weights and (ii) information indicating beam restrictions of the RU including supported subbands and a total number of JPTA beams, and
the JPTA configuration includes per subband beam identifiers.

5. The RU of claim 4, wherein the beam restrictions further indicate available azimuth and elevation angles across the supported subbands.

6. The RU of claim 4, wherein the beam restrictions further indicate a capability to support a mix of coarse and fine beams.

7. The RU of claim 1, wherein:
the beamforming capability information indicates a weight-based dynamic beamforming (WDBF) capability,
the beamforming capability information includes a plurality of bits indicating a delay unit to antenna element (AE) mapping between AEs and delay units of the RU, and
the plurality of bits in the transmitted beamforming capability information are less than a number of bits needed to indicate a mapping between each of AE and delay unit of the RU.

8. A distributed unit (DU), comprising:
a fronthaul interface configured to:
receive, from a radio unit (RU) via a management-plane (M-plane), information indicating support for joint phase-time array (JPTA) beamforming; and
receive, from the RU, beamforming capability information associated with a frontend architecture of a transceiver of the RU; and
a processor operably coupled with the fronthaul interface, the processor configured to determine a JPTA configuration based on the information indicating support for JPTA beamforming and the beamforming capability information,
wherein the fronthaul interface is further configured to transmit, to the RU, the JPTA configuration to indicate a JPTA beam to apply for a transmission.

9. The DU of claim 8, wherein:
the beamforming capability information indicates a weight-based dynamic beamforming (WDBF) capability,
the beamforming capability information includes information about a delay unit to antenna element (AE) mapping between AEs and delay units of the RU,
the information about the delay unit to AE mapping includes a plurality of bits,
each bit in the plurality of bits indicates an association between one of the delay units and one of the AEs, and
the JPTA configuration includes a delay vector and a phase vector.

10. The DU of claim 8, wherein:
the beamforming capability information indicates a predefined beamforming (PDBF) capability,
the beamforming capability information includes JPTA beam identifiers (IDs) and subband (SB) beam IDs associated with one or more of the JPTA beam IDs,
each of the SB beam IDs indicate a beam ID, a starting physical resource block (PRB), a number of PRB, a carrier component identifier, and a beam gain, and
the JPTA configuration indicates a JPTA beam identifier from the JPTA beam IDs.

11. The DU of claim 8, wherein
the beamforming capability information indicates an attribute-based dynamic beamforming (ADBF) capability,
the beamforming capability information includes (i) information indicating a capability to compute JPTA beamforming weights and (ii) information indicating beam restrictions of the RU including supported subbands and a total number of JPTA beams, and
the JPTA configuration includes per subband beam identifiers.

12. The DU of claim 11, wherein the beam restrictions further indicate available azimuth and elevation angles across the supported subbands.

13. The DU of claim 11, wherein the beam restrictions further indicate a capability to support a mix of coarse and fine beams.

14. The DU of claim 8, wherein:
the beamforming capability information indicates a weight-based dynamic beamforming (WDBF) capability,
the beamforming capability information includes a plurality of bits indicating a delay unit to antenna element (AE) mapping between AEs and delay units of the RU, and
the plurality of bits in the received beamforming capability information are less than a number of bits needed to indicate a mapping between each of AE and delay unit of the RU.

15. A method performed by a radio unit (RU), the method comprising:
transmitting, to a distributed unit (DU) via a management-plane (M-plane) of a fronthaul interface, information indicating support for joint phase-time array (JPTA) beamforming;
transmitting, to the DU, beamforming capability information associated with a frontend architecture of a transceiver of the RU;
receiving, from the DU, a JPTA configuration based on the beamforming capability information;
identifying a JPTA beam to apply based on the JPTA configuration; and
transmitting, to one or more user equipment (UEs), the JPTA beam.

16. The method of claim 15, wherein:
the beamforming capability information indicates a weight-based dynamic beamforming (WDBF) capability,
the beamforming capability information includes information about a delay unit to antenna element (AE) mapping between AEs and delay units of the RU,
the information about the delay unit to AE mapping includes a plurality of bits,
each bit in the plurality of bits indicates an association between one of the delay units and one of the AEs, and
the JPTA configuration includes a delay vector and a phase vector.

17. The method of claim 15, wherein:
the beamforming capability information indicates a predefined beamforming (PDBF) capability,
the beamforming capability information includes JPTA beam identifiers (IDs) and subband (SB) beam IDs associated with one or more of the JPTA beam IDs,
each of the SB beam IDs indicate a beam ID, a starting physical resource block (PRB), a number of PRB, a carrier component identifier, and a beam gain, and
the JPTA configuration indicates a JPTA beam identifier from the JPTA beam IDs.

18. The method of claim 15, wherein
the beamforming capability information indicates an attribute-based dynamic beamforming (ADBF) capability,
the beamforming capability information includes (i) information indicating a capability to compute JPTA beamforming weights and (ii) information indicating beam restrictions of the RU including supported subbands and a total number of JPTA beams, and
the JPTA configuration includes per subband beam identifiers.

19. The method of claim 18, wherein the beam restrictions further indicate available azimuth and elevation angles across the supported subbands.

20. The method of claim 18, wherein the beam restrictions further indicate a capability to support a mix of coarse and fine beams.
